(19) United States
(12) Patent Application Publication
(10) Pub. No.: US 2026/0262647 A1
(43) Pub. Date: Sep. 10, 2026

(54) Synergistic Compositions Containing Guanidine

(71) Applicant: Thor GmbH, Speyer (DE)

(72) Inventors: Thomas Wunder, Neustadt a.d. Weinstrasse (DE); Roman Grabbe, Neustadt a.d. Weinstrasse (DE)

(73) Assignee: Thor GmbH, Speyer (DE)

(21) Appl. No.: 19/159,294

(22) PCT Filed: Feb. 16, 2024
(86) PCT No.: PCT/EP2024/000009

§ 371 Date: Aug. 22, 2025

(30) Foreign Application Priority Data
Feb. 23, 2023 (EP) 23000031.7

(51) Int. Cl. A01N 47/44; A01N 31/02; A01N 31/04; A01N 31/14; A01N 33/08; A01N 33/20; A01N 37/06; A01N 37/34; A01N 37/40; A01N 37/44; A01N 43/40; A01N 43/80; A01N 47/12; A01N 57/20; A01N 59/16; A01P 1/00

(52) U.S. Cl. CPC A01N 47/44; A01N 31/02; A01N 31/04; A01N 31/14; A01N 33/08; A01N 33/20; A01N 37/06; A01N 37/34; A01N 37/40; A01N 37/44; A01N 43/40; A01N 43/80; A01N 47/12; A01N 57/20; A01N 59/16; A01P 1/00

(57) ABSTRACT

The present invention relates to a composition, containing (a) guanidine and/or a salt of the non-substituted guanidine, and (b) at least one further component, selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, bronopol, dibromnitrilopropion amide, dibromodicyanobutane, iodpropinyl butylcarbamate, amino-methyl-propanol, amino-ethyl-propanediol, monoethanolamine, ethylhexylglycerine, hexylglycerine, 1,2-pentanediol, 1,2-hexanediol, 1,2-heptanediol, 1,2-octanediol, phenoxyethanol, phenethyl alcohol, phenylpropanol, benzyl alcohol, isopropanol, ethylenediaminetetraacetic acid, (1-hydroxy ethylidene)bis-phosphonic acid, sodium pyrithione, zinc pyrithione, o-phenylphenol, sorbic acid, benzoic acid, salicylic acid, lactic acid, citric acid and zinc. The invention furthermore relates to technical products which contain the components (a) and (b), and to the use of the compositions for container conserving and the conserving of technical products. The invention also relates to the use of (a) guanidine and/or a salt of the non-substituted guanidine to improve the antimicrobial effectiveness of one or more compounds, selected from the aforementioned group (b).

The present invention relates to a composition comprising (a) guanidine and/or a salt of unsubstituted guanidine and (b) at least one further component selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, bronopol, dibromonitrilopropionamide, dibromodicyanobutane, iodopropynyl butylcarbamate, aminomethylpropanol, aminoethylpropanediol, monoethanolamine, ethylhexylglycerol, hexylglycerol, pentane-1,2-diol, hexane-1,2-diol, heptane-1,2-diol, octane-1,2-diol, phenoxyethanol, phenethyl alcohol, phenylpropanol, benzyl alcohol, isopropanol, ethylenediaminetetraacetic acid, (1-hydroxyethylidene)bisphosphonic acid, sodium pyrithione, zinc pyrithione, o-phenylphenol, sorbic acid, benzoic acid, salicylic acid, lactic acid, citric acid and zinc. The invention further relates to industrial products containing components (a) and (b) and to the use of the compositions for in-can preservation and the preservation of industrial products. The invention likewise relates to the use of (a) guanidine and/or a salt of unsubstituted guanidine for improving the antimicrobial efficacy of one or more compound(s) selected from group (b) defined above.

Industrial products, in particular aqueous industrial products such as paints, varnishes, emulsions, washing and cleaning compositions and cosmetic products, are customarily produced using natural or biodegradable raw materials. These raw materials and the water used as solvent are frequently contaminated with microbes, such as bacteria, yeasts and fungi. If these products are produced without a preservative, they may have high microbial counts even one day after production.

In order to ensure that the hygiene requirements are met by these products, and if appropriate also the constituents thereof used in production, and hence that the shelf life of the industrial products is assured, what are called biocides are usually added to the products, or directly to the constituents thereof.

One class of biocides used for preservation of aqueous industrial products such as paints, renders, washing and cleaning compositions, glazes, or constituents thereof, is that of what are called the 3-isothiazolin-3-ones. This substance class includes antimicrobially very active compounds with a profile of action that differs to some degree. It is often also the case that synergistic combinations of different 3-isothiazolin-3-ones are used in order to reduce the amount of biocides used. For example, WO 99/08530 A1 thus suggests the combined use of methylisothiazolin-3-one and 1,2-benzoisothiazolin-3-one.

EP-B 1 030 558 likewise discloses a synergistic biocidal composition containing 2-methylisothiazolin-3-one and 3-iodo-2-propynyl N-butylcarbamate. This synergistic composition is suitable even in low concentrations for controlling microorganisms.

A further class of biocides is that of what are called the alkylguanidinium salts and also polyguanidinium salts. For example, it is thus known from the “Directory of microbicides for the protection of materials”, Springer 2005, pages 726 to 731, that an antimicrobial effect is possessed by medium- and long-chain guanidines and biguanidines, such as cocopropylenediamine-1,5-bisguanidinium acetates, bis(guanidinooctyl)amine triacetates, poly(hexamethylenebiguanidine) hydrochlorides, di(4′-chlorophenyldiguanido)hexanes, chlorhexidine digluconates, chlorhexidine diacetates.

Also known is the use of such medium- and long-chain guanidine compounds together with other antimicrobial and/or fungicidal actives. For instance, a known example is the combination with 3-iodo-2-propynyl butylcarbamate, or formaldehyde depots. For example, EP 0 891 710 A1 thus teaches the combined use of dodecylguanidine hydrochloride and IPBC. However, the use of dodecylguanidine salts for preservation of paint compositions and polymer dispersions has been found to be problematic; for instance, incompatibilities in the form of coagulations were observable when these salts were added.

Proceeding from the prior art discussed above, there is a need for further compositions, the components of which interact synergistically and, when used simultaneously, can therefore be used in lower concentrations compared to the concentrations necessary in the case of the individual components.

The invention achieves this object by a composition, preferably an aqueous composition, comprising:
(a) guanidine and/or a salt of unsubstituted guanidine, and
(b) at least one further component selected from the group consisting of 5-chloro-2-methyl-4-isothiazolin-3-one (CMIT), 2-methyl-4-isothiazolin-3-one (MIT), 1,2-benzisothiazolin-3-one (BIT), N-butyl-1,2-benzisothiazolin-3-one (BBIT), N-methyl-1,2-benzisothiazolin-3-one (MBIT), octylisothiazolinone (OIT), bronopol, dibromonitrilopropionamide (DBNPA), dibromodicyanobutane (DBDCB), iodopropynyl butylcarbamate (IPBC), aminomethylpropanol (AMP), aminoethylpropanediol (AEPD), monoethanolamine (MEA), ethylhexylglycerol, hexylglycerol, pentane-1,2-diol, hexane-1,2-diol, heptane-1,2-diol, octane-1,2-diol, phenoxyethanol, phenethyl alcohol, phenylpropanol, benzyl alcohol, isopropanol, ethylenediaminetetraacetic acid (EDTA), (1-hydroxyethylidene)bisphosphonic acid (HEDP), sodium pyrithione, zinc pyrithione, o-phenylphenol (oPP), sorbic acid, benzoic acid, salicylic acid, lactic acid, citric acid and zinc.

The composition of the invention has the advantage that the guanidine or its salt, component (a), which has not been known as an antimicrobial active to date, and the at least one further component from the group shown above, group (b), interact synergistically, and can therefore be used in low concentrations when used at the same time, compared to low concentrations in the case of the individual components.

In the context of the present invention, what is meant by “at least one further component” is that the composition contains a single component or compound selected from the group, or several, i.e. two, three, four, five or more components or compounds, from the group.

In the context of the present invention, both the amounts of the respective components (a) and (b) and the weight ratios of the components (a) and (b) to one another are specified. The amounts refer respectively to the lead structures, the guanidine, or to the lead structure of the component (b). The determination of the specified weight ratios is likewise based in each case on the content in respect of the guanidine, without taking into account any counterion, and the content of the lead structure of the further component (b), without taking into account any counterion, in the composition.

For the purposes of the present invention, what is meant by guanidine and/or a salt of unsubstituted guanidine is that the composition contains, as active component (a), the guanidine and/or thus optionally also one or more salts of unsubstituted guanidine. The guanidine is the compound of the formula shown below:

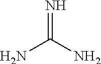

The salts of unsubstituted guanidine or guanidine salts in the context of the present invention are guanidine or guanidinium salts of the general formula shown below:

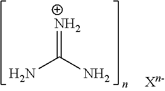

where n is 1, 2 or 3, and where the counterion Xⁿ⁻ is, for example, chloride, carbonate, nitrate, sulfate, thiocyanate, phosphate, hydrogencarbonate, formate, acetate or citrate.

In a preferred embodiment of the invention, the composition of the invention contains guanidine hydrochloride and/or guanidine carbonate as component (a), and in a particularly preferred embodiment of the invention the composition contains guanidine carbonate as component (a).

The amount of component (a), guanidine and/or its salt, which is present in the preferably aqueous composition of the invention may vary over wide ranges and is generally in the range from 100 to 10 000 ppm, preferably in an amount in the range from 200 to 7500 ppm, and more preferably in an amount in the range from 300 to 5000 ppm, where the proportion relates to the guanidine content in the overall aqueous composition.

The amount of components (a) and (b) present in the preferably aqueous composition of the invention may vary over wide ranges. In one embodiment, the composition is characterized in that it contains the guanidine and/or its salt and the at least one further component in a total amount in the range from 0.01% to 10%, preferably in the range from 0.02% to 5% and more preferably in the range from 0.03% to 3%, based on the overall composition.

The water content in the preferably aqueous composition of the invention may vary over wide ranges. Typically, the composition is characterized in that it has a water content of greater than 1% by weight, preferably of greater than 10% by weight, more preferably of greater than 20% by weight, based on the overall composition.

The pH of the aqueous composition may vary over wide ranges and is generally in a range from pH 4.5 to pH 12, preferably in the range from pH 5.0 to 11.5, more preferably in the range from pH 5.5 to pH 11. The pH can be adjusted to the claimed range with the aid of measures familiar to the person skilled in the art.

The preferred weight ratios of components (a) to (b) to one another under which a surprisingly good antimicrobial effect can be achieved, as can be seen from the examples, may be individually different.

### Synergistic Composition Containing guanidine and 5-chloro-2-methylisothiazolin-3-one (CIT)

In one embodiment, the invention relates to a composition containing guanidine and/or its salt, and also 5-chloro-2-methylisothiazolin-3-one.

In a preferred embodiment, the invention relates to a composition containing guanidine and/or its salt and 5-chloro-2-methylisothiazolin-3-one, in a weight ratio of guanidine and/or its salt to 5-chloro-2-methylisothiazolin-3-one in the range from 62:1 to 9270:1, preferably in the range from 62:1 to 500:1, more preferably in the range from 62:1 to 300:1, where the basis in the determination of the weight ratio in each case is the content with respect to the guanidine, without taking into account any counterion, and the 5-chloro-2-methylisothiazolin-3-one in the composition.

### Synergistic Composition Containing guanidine and 2-methylisothiazolin-3-one (MIT)

In one embodiment, the invention relates to a composition containing guanidine and/or its salt and 2-methylisothiazolin-3-one.

In a preferred embodiment, the invention relates to a composition containing guanidine and/or its salt and 2-methylisothiazolin-3-one, in a weight ratio of guanidine to 2-methylisothiazolin-3-one generally in the range from 10.3:1 to 773:1, preferably in the range from 10.3:1 to 500:1, more preferably in the range from 10.3:1 to 300:1, where the basis in the determination of the weight ratio in each case is the content with respect to the guanidine, without taking into account any counterion, and the 2-methylisothiazolin-3-one in the composition.

### Synergistic Composition Containing guanidine and 1,2-benzisothiazolin-3-one (BIT)

In one embodiment, the invention relates to a composition containing guanidine and/or its salt and 1,2-benzisothiazolin-3-one.

In a preferred embodiment, the invention relates to a composition containing guanidine and/or its salt and 1,2-benzisothiazolin-3-one, in a weight ratio of guanidine to 1,2-benzisothiazolin-3-one generally in the range from 1.3:1 to 309:1, preferably in the range from 1.3:1 to 200:1, more preferably in the range from 1.3:1 to 100:1, where the basis in the determination of the weight ratio in each case is the content with respect to the guanidine, without taking into account any counterion, and the 1,2-benzisothiazolin-3-one in the composition.

### Synergistic Composition Containing guanidine and N-butyl-1,2-benzisothiazolin-3-one (BBIT)

In one embodiment, the invention relates to a composition containing guanidine and/or its salt and N-butyl-1,2-benzisothiazolin-3-one.

In a preferred embodiment, the invention relates to a composition containing guanidine and/or its salt and N-butyl-1,2-benzisothiazolin-3-one, in a weight ratio of guanidine to N-butyl-1,2-benzisothiazolin-3-one generally in the range from 0.52:1 to 309:1, preferably in the range from 0.52:1 to 200:1, more preferably in the range from 0.52:1 to 100:1, where the basis in the determination of the weight ratio in each case is the content with respect to the guanidine, without taking into account any counterion, and the N-butyl-1,2-benzisothiazolin-3-one in the composition.

### Synergistic Composition Containing guanidine and N-methyl-1,2-benzisothiazolin-3-one (MBIT)

In one embodiment, the invention relates to a composition containing guanidine and/or its salt and N-methyl-1,2-benzisothiazolin-3-one.

In a preferred embodiment, the invention relates to a composition containing guanidine and N-methyl-1,2-benzisothiazolin-3-one, in a weight ratio of guanidine to N-methyl-1,2-benzisothiazolin-3-one generally in the range from 7.8:1 to 618:1, preferably in the range from 7.8:1 to 400:1, more preferably in the range from 7.8:1 to 300:1, where the basis in the determination of the weight ratio in each case is the content with respect to the guanidine, without taking into account any counterion, and the N-methyl-1,2-benzisothiazolin-3-one in the composition.

### Synergistic Composition Containing guanidine and N-octylisothiazolin-3-one

In one embodiment, the invention relates to a composition containing guanidine and/or its salt and N-octylisothiazolin-3-one.

In a preferred embodiment, the invention relates to a composition containing guanidine and N-octylisothiazolin-3-one, in a weight ratio of guanidine to N-octylisothiazolin-3-one generally in the range from 1.4:1 to 82:1, preferably in the range from 1.4:1 to 50:1, where the basis in the determination of the weight ratio in each case is the content with respect to the guanidine, without taking into account any counterion, and the N-octylisothiazolin-3-one in the composition.

### Synergistic Composition Containing guanidine and bronopol

In one embodiment, the invention relates to a composition containing guanidine and/or its salt and bronopol.

In a preferred embodiment, the invention relates to a composition containing guanidine and bronopol, in a weight ratio of guanidine to bronopol generally in the range from 7.8:1 to 824:1, preferably in the range from 7.8:1 to 200:1, more preferably in the range from 7.8:1 to 100:1, where the basis in the determination of the weight ratio in each case is the content with respect to the guanidine, without taking into account any counterion, and the bronopol in the composition.

### Synergistic Composition Containing guanidine and 2,2-dibromo-3-nitrilopropionamide

In one embodiment, the invention relates to a composition containing guanidine and/or its salt and 2,2-dibromo-3-nitrilopropionamide.

In a preferred embodiment, the invention relates to a composition containing guanidine and 2,2-dibromo-3-nitrilopropionamide, in a weight ratio of guanidine to 2,2-dibromo-3-nitrilopropionamide generally in the range from 7.8:1 to 3090:1, preferably in the range from 7.8:1 to 250:1, more preferably in the range from 7.8:1 to 100:1, where the basis in the determination of the weight ratio in each case is the content with respect to the guanidine, without taking into account any counterion, and the 2,2-dibromo-3-nitrilopropionamide in the composition.

### Synergistic Composition Containing guanidine and dibromodicyanobutane (DBDCB)

In one embodiment, the invention relates to a composition containing guanidine and/or its salt and dibromodicyanobutane.

In a preferred embodiment, the invention relates to a composition containing guanidine and dibromodicyanobutane, in a weight ratio of guanidine to dibromodicyanobutane generally in the range from 0.78:1 to 309:1, preferably in the range from 0.8:1 to 200:1, more preferably in the range from 0.8:1 to 100:1, where the basis in the determination of the weight ratio in each case is the content with respect to the guanidine, without taking into account any counterion, and the dibromodicyanobutane in the composition.

### Synergistic Composition Containing guanidine and iodopropynyl butylcarbamate (IPBC)

In one embodiment, the invention relates to a composition containing guanidine and/or its salt and iodopropynyl butylcarbamate.

In a preferred embodiment, the invention relates to a composition containing guanidine and iodopropynyl butylcarbamate, in a weight ratio of guanidine to iodopropynyl butylcarbamate generally in the range from 0.83:1 to 103:1, preferably in the range from 1:1 to 90:1, more preferably in the range from 1:1 to 80:1, where the basis in the determination of the weight ratio in each case is the content with respect to the guanidine, without taking into account any counterion, and the iodopropynyl butylcarbamate in the composition.

### Synergistic Composition Containing guanidine and 2-amino-2-methyl-1-propanol (AMP)

In one embodiment, the invention relates to a composition containing guanidine and/or its salt and 2-amino-2-methyl-1-propanol.

In a preferred embodiment, the invention relates to a composition containing guanidine and 2-amino-2-methyl-1-propanol, in a weight ratio of guanidine to 2-amino-2-methyl-1-propanol generally in the range from 0.3:1 to 20:1, preferably in the range from 0.5:1 to 15:1, more preferably in the range from 1:1 to 10:1, where the basis in the determination of the weight ratio in each case is the content with respect to the guanidine, without taking into account any counterion, and the 2-amino-2-methyl-1-propanol in the composition.

### Synergistic Composition Containing guanidine and 2-aminoethylpropane-1,3-diol (AEPD)

In one embodiment, the invention relates to a composition containing guanidine and/or its salt and 2-aminoethylpropane-1,3-diol.

In a preferred embodiment, the invention relates to a composition containing guanidine and 2-aminoethylpropane-1,3-diol, in a weight ratio of guanidine to 2-aminoethylpropane-1,3-diol generally in the range from 0.2:1 to 15:1, preferably in the range from 0.5:1 to 10:1, more preferably in the range from 1:1 to 10:1, where the basis in the determination of the weight ratio in each case is the content with respect to the guanidine, without taking into account any counterion, and the 2-aminoethylpropane-1,3-diol in the composition.

### Synergistic Composition Containing guanidine and monoethanolamine (MEA)

In one embodiment, the invention relates to a composition containing guanidine and/or its salt and monoethanolamine.

In a preferred embodiment, the invention relates to a composition containing guanidine and monoethanolamine, in a weight ratio of guanidine to monoethanolamine generally in the range from 0.2:1 to 30:1, preferably in the range from 0.5:1 to 20:1, more preferably in the range from 1:1 to 10:1, where the basis in the determination of the weight ratio in each case is the content with respect to the guanidine, without taking into account any counterion, and the monoethanolamine in the composition.

### Synergistic Composition Containing guanidine and ethylhexylglycerol

In one embodiment, the invention relates to a composition containing guanidine and/or its salt and ethylhexylglycerol.

In a preferred embodiment, the invention relates to a composition containing guanidine and ethylhexylglycerol, in a weight ratio of guanidine to ethylhexylglycerol generally in the range from 0.5:1 to 15:1, preferably in the range from 0.5:1 to 10:1, where the basis in the determination of the weight ratio in each case is the content with respect to the guanidine, without taking into account any counterion, and the monoethanolamine in the composition.

### Synergistic Composition Containing guanidine and hexylglycerol

In one embodiment, the invention relates to a composition containing guanidine and/or its salt and hexylglycerol.

In a preferred embodiment, the invention relates to a composition containing guanidine and hexylglycerol, in a weight ratio of guanidine to hexylglycerol generally in the range from 0.5:1 to 15:1, preferably in the range from 0.5:1 to 10:1, where the basis in the determination of the weight ratio in each case is the content with respect to the guanidine, without taking into account any counterion, and the hexylglycerol in the composition.

### Synergistic Composition Containing guanidine and pentane-1,2-diol

In one embodiment, the invention relates to a composition containing guanidine and/or its salt and pentane-1,2-diol.

In a preferred embodiment, the invention relates to a composition containing guanidine and pentane-1,2-diol, in a weight ratio of guanidine to pentane-1,2-diol generally in the range from 0.07:1 to 7.5:1, preferably in the range from 0.1:1 to 7.5:1, more preferably in the range from 0.5:1 to 7.5:1, where the basis in the determination of the weight ratio in each case is the content with respect to the guanidine, without taking into account any counterion, and the pentane-1,2-diol in the composition.

### Synergistic Composition Containing guanidine and hexane-1,2-diol

In one embodiment, the invention relates to a composition containing guanidine and/or its salt and hexane-1,2-diol.

In a preferred embodiment, the invention relates to a composition containing guanidine and hexane-1,2-diol, in a weight ratio of guanidine to hexane-1,2-diol generally in the range from 0.06:1 to 15:1, preferably in the range from 0.1:1 to 10:1, more preferably in the range from 0.5:1 to 10:1, where the basis in the determination of the weight ratio in each case is the content with respect to the guanidine, without taking into account any counterion, and the hexane-1,2-diol in the composition.

### Synergistic Composition Containing guanidine and heptane-1,2-diol

In one embodiment, the invention relates to a composition containing guanidine and/or its salt and heptane-1,2-diol.

In a preferred embodiment, the invention relates to a composition containing guanidine and heptane-1,2-diol, in a weight ratio of guanidine to heptane-1,2-diol generally in the range from 0.25:1 to 30:1, preferably in the range from 0.5:1 to 20:1, more preferably in the range from 0.5:1 to 10:1, where the basis in the determination of the weight ratio in each case is the content with respect to the guanidine, without taking into account any counterion, and the heptane-1,2-diol in the composition.

### Synergistic Composition Containing guanidine and octane-1,2-diol

In one embodiment, the invention relates to a composition containing guanidine and/or its salt and octane-1,2-diol.

In a preferred embodiment, the invention relates to a composition containing guanidine and octane-1,2-diol, in a weight ratio of guanidine to octane-1,2-diol generally in the range from 0.2:1 to 6:1, preferably in the range from 0.5:1 to 6:1, where the basis in the determination of the weight ratio in each case is the content with respect to the guanidine, without taking into account any counterion, and the octane-1,2-diol in the composition.

### Synergistic Composition Containing guanidine and phenoxyethanol

In one embodiment, the invention relates to a composition containing guanidine and/or its salt and phenoxyethanol.

In a preferred embodiment, the invention relates to a composition containing guanidine and phenoxyethanol, in a weight ratio of guanidine to phenoxyethanol generally in the range from 0.13:1 to 3.6:1, preferably in the range from 0.3:1 to 3.6:1, more preferably in the range from 0.5:1 to 3.6:1, where the basis in the determination of the weight ratio in each case is the content with respect to the guanidine, without taking into account any counterion, and the phenoxyethanol in the composition.

### Synergistic Composition Containing guanidine and phenethyl alcohol

In one embodiment, the invention relates to a composition containing guanidine and/or its salt and phenethyl alcohol.

In a preferred embodiment, the invention relates to a composition containing guanidine and phenethyl alcohol, in a weight ratio of guanidine to phenethyl alcohol generally in the range from 0.15:1 to 12:1, preferably in the range from 0.3:1 to 12:1, more preferably in the range from 0.5:1 to 12:1, where the basis in the determination of the weight ratio in each case is the content with respect to the guanidine, without taking into account any counterion, and the phenoxyethanol in the composition.

### Synergistic Composition Containing guanidine and phenylpropanol

In one embodiment, the invention relates to a composition containing guanidine and/or its salt and phenylpropanol.

In a preferred embodiment, the invention relates to a composition containing guanidine and phenylpropanol, in a weight ratio of guanidine to phenylpropanol generally in the range from 0.4:1 to 6:1, preferably in the range from 0.5:1 to 6:1, where the basis in the determination of the weight ratio in each case is the content with respect to the guanidine, without taking into account any counterion, and the phenoxyethanol in the composition.

### Synergistic Composition Containing guanidine and benzyl alcohol

In one embodiment, the invention relates to a composition containing guanidine and/or its salt and benzyl alcohol.

In a preferred embodiment, the invention relates to a composition containing guanidine and benzyl alcohol, in a weight ratio of guanidine to benzyl alcohol generally in the range from 1:1 to 12:1, preferably in the range from 1:1 to 10:1, where the basis in the determination of the weight ratio in each case is the content with respect to the guanidine, without taking into account any counterion, and the benzyl alcohol in the composition.

### Synergistic Composition Containing guanidine and isopropanol

In one embodiment, the invention relates to a composition containing guanidine and/or its salt and isopropanol.

In a preferred embodiment, the invention relates to a composition containing guanidine and isopropanol, in a weight ratio of guanidine to isopropanol generally in the range from 0.004:1 to 3:1, preferably in the range from 0.01:1 to 3:1, more preferably 0.1 to 3:1, where the basis in the determination of the weight ratio in each case is the content with respect to the guanidine, without taking into account any counterion, and the isopropanol in the composition.

### Synergistic Composition Containing guanidine and ethylenediaminetetraacetic acid (EDTA)

In one embodiment, the invention relates to a composition containing guanidine and/or its salt and ethylenediaminetetraacetic acid and/or its salt(s).

In a preferred embodiment, the invention relates to a composition containing guanidine and ethylenediaminetetraacetic acid, in a weight ratio of guanidine to ethylenediaminetetraacetic acid generally in the range from 0.6:1 to 37:1, preferably in the range from 0.6:1 to 20:1, more preferably 0.6:1 to 15:1, where the basis in the determination of the weight ratio in each case is the content with respect to the guanidine, without taking into account any counterion, and the ethylenediaminetetraacetic acid in the composition.

### Synergistic Composition Containing guanidine and (1-hydroxyethylidene)bisphosphonic acid (HEDP)

In one embodiment, the invention relates to a composition containing guanidine and/or its salt and (1-hydroxyethylidene)bisphosphonic acid and/or its salt(s).

In a preferred embodiment, the invention relates to a composition containing guanidine and (1-hydroxyethylidene)bisphosphonic acid, in a weight ratio of guanidine to (1-hydroxyethylidene)bisphosphonic acid generally in the range from 0.6:1 to 1.5:1, preferably in the range from 0.6:1 to 1:1, where the basis in the determination of the weight ratio in each case is the content with respect to the guanidine, without taking into account any counterion, and the (1-hydroxyethylidene)bisphosphonic acid in the composition.

### Synergistic Composition Containing guanidine and sodium pyrithione

In one embodiment, the invention relates to a composition containing guanidine and/or its salt and sodium pyrithione.

In a preferred embodiment, the invention relates to a composition containing guanidine and sodium pyrithione, in a weight ratio of guanidine to sodium pyrithione generally in the range from 3.6:1 to 180:1, preferably in the range from 3.6:1 to 100:1, more preferably 3.6:1 to 50:1, where the basis in the determination of the weight ratio in each case is the content with respect to the guanidine, without taking into account any counterion, and the sodium pyrithione in the composition.

### Synergistic Composition Containing guanidine and zinc pyrithione

In one embodiment, the invention relates to a composition containing guanidine and/or its salt and zinc pyrithione.

In a preferred embodiment, the invention relates to a composition containing guanidine and zinc pyrithione, in a weight ratio of guanidine to zinc pyrithione generally in the range from 3.6:1 to 180:1, preferably in the range from 3.6:1 to 100:1, more preferably 3.6:1 to 50:1, where the basis in the determination of the weight ratio in each case is the content with respect to the guanidine, without taking into account any counterion, and the zinc pyrithione in the composition.

### Synergistic Composition Containing guanidine and o-phenylphenol (oPP)

In one embodiment, the invention relates to a composition containing guanidine and/or its salt and o-phenylphenol.

In a preferred embodiment, the invention relates to a composition containing guanidine and o-phenylphenol, in a weight ratio of guanidine to o-phenylphenol generally in the range from 0.62:1 to 49:1, preferably in the range from 0.62:1 to 40:1, more preferably 0.62:1 to 30:1, where the basis in the determination of the weight ratio in each case is the content with respect to the guanidine, without taking into account any counterion, and the o-phenylphenol in the composition.

### Synergistic Composition Containing guanidine and sorbic acid

In one embodiment, the invention relates to a composition containing guanidine and/or its salt, and also sorbic acid and/or its salt(s).

In a preferred embodiment, the invention relates to a composition containing guanidine and sorbic acid, in a weight ratio of guanidine to sorbic acid generally in the range from 0.1:1 to 50:1, preferably in the range from 0.25:1 to 40:1, more preferably 0.25:1 to 30:1, where the basis in the determination of the weight ratio in each case is the content with respect to the guanidine, without taking into account any counterion, and the sorbic acid in the composition.

### Synergistic Composition Containing guanidine and benzoic acid

In one embodiment, the invention relates to a composition containing guanidine and/or its salt and benzoic acid and/or its salt(s).

In a preferred embodiment, the invention relates to a composition containing guanidine and benzoic acid, in a weight ratio of guanidine to benzoic acid generally in the range from 0.25:1 to 88:1, preferably in the range from 0.25:1 to 50:1, more preferably 0.25:1 to 30:1, where the basis in the determination of the weight ratio in each case is the content with respect to the guanidine, without taking into account any counterion, and the benzoic acid in the composition.

### Synergistic Composition Containing guanidine and salicylic acid

In one embodiment, the invention relates to a composition containing guanidine and/or its salt and salicylic acid and/or its salt(s).

In a preferred embodiment, the invention relates to a composition containing guanidine and salicylic acid, in a weight ratio of guanidine to salicylic acid generally in the range from 0.24:1 to 43:1, preferably in the range from 0.24:1 to 30:1, where the basis in the determination of the weight ratio in each case is the content with respect to the guanidine, without taking into account any counterion, and the salicylic acid in the composition.

### Synergistic Composition Containing guanidine and lactic acid

In one embodiment, the invention relates to a composition containing guanidine and/or its salt and lactic acid and/or its salt(s).

In a preferred embodiment, the invention relates to a composition containing guanidine and lactic acid, in a weight ratio of guanidine to lactic acid generally in the range from 0.03:1 to 23:1, preferably in the range from 0.03:1 to 10:1, where the basis in the determination of the weight ratio in each case is the content with respect to the guanidine, without taking into account any counterion, and the lactic acid in the composition.

### Synergistic Composition Containing guanidine and citric acid

In one embodiment, the invention relates to a composition containing guanidine and/or its salt and citric acid and/or its salt(s).

In a preferred embodiment, the invention relates to a composition containing guanidine and citric acid, in a weight ratio of guanidine to citric acid in the range from 1:0.014 to 12:1, where the basis in the determination of the weight ratio in each case is the content with respect to the guanidine, without taking into account any counterion, and the citric acid in the composition.

### Synergistic Composition Containing guanidine and zinc

In one embodiment, the invention relates to a composition containing guanidine and/or its salt and zinc. In the context of the present invention, the zinc is provided by at least one zinc compound, which serves as a zinc source. The zinc compound is preferably selected from the group consisting of zinc oxide, zinc chloride, zinc sulfate, zinc phosphate, zinc carbonate, zinc ascorbate, zinc dehydroacetate, zinc hydroxide and zinc carboxylate. In a preferred embodiment of the invention, the zinc compound is selected from the group consisting of zinc oxide, zinc chloride and zinc carbonate. The zinc is most preferably provided, or introduced into the composition, by zinc oxide.

In a preferred embodiment, the invention relates to a composition containing guanidine and zinc, in a weight ratio of guanidine to zinc in the range from 0.77:1 to 12:1, preferably 1:1 to 12:1, where the basis in the determination of the weight ratio in each case is the content with respect to the guanidine, without taking into account any counterion, and with respect to the zinc ion.

In a preferred embodiment of the invention, the composition of the invention is characterized in that
the weight ratio of guanidine and/or its salt to 5-chloro-2-methylisothiazolin-3-one is in the range from 62:1 to 9270:1,
that the weight ratio of guanidine and/or its salt to 2-methyl-4-isothiazolin-3-one is in the range from 10.3:1 to 773:1,
that the weight ratio of guanidine and/or its salt to 1,2-benzisothiazolin-3-one is in the range from 1.3:1 to 309:1,
that the weight ratio of guanidine and/or its salt to N-butyl-1,2-benzisothiazolin-3-one is in the range from 0.52:1 to 309:1,
that the weight ratio of guanidine and/or its salt to N-methyl-1,2-benzisothiazolin-3-one is in the range from 7.8:1 to 618:1,
that the weight ratio of guanidine and/or its salt to N-octylisothiazolin-3-one is in the range from 1.4:1 to 82:1,
that the weight ratio of guanidine and/or its salt to bronopol is in the range from 7.8:1 to 824:1,
that the weight ratio of guanidine and/or its salt to 2,2-dibromo-3-nitrilopropionamide is in the range from 7.8:1 to 3090:1,
that the weight ratio of guanidine and/or its salt to dibromodicyanobutane is in the range from 0.78:1 to 309:1,
that the weight ratio of guanidine and/or its salt to iodopropynyl butylcarbamate is in the range from 0.83:1 to 103:1,
that the weight ratio of guanidine and/or its salt to 2-amino-2-methyl-1-propanol is in the range from 0.3:1 to 20:1,
that the weight ratio of guanidine and/or its salt to 2-aminoethylpropane-1,3-diol is in the range from 0.2:1 to 15:1,
that the weight ratio of guanidine and/or its salt to monoethanolamine is in the range from 0.2:1 to 30:1,
that the weight ratio of guanidine and/or its salt to ethylhexylglycerol is in the range from 0.5:1 to 15:1,
that the weight ratio of guanidine and/or its salt to hexylglycerol is in the range from 0.5:1 to 15:1, preferably in the range from 0.5:1 to 10:1,
that the weight ratio of guanidine and/or its salt to pentane-1,2-diol is in the range from 0.07:1 to 7.5:1,
that the weight ratio of guanidine and/or its salt to hexane-1,2-diol is in the range from 0.06:1 to 15:1,
that the weight ratio of guanidine and/or its salt to heptane-1,2-diol is in the range from 0.25:1 to 30:1,
that the weight ratio of guanidine and/or its salt to octane-1,2-diol is in the range from 0.2:1 to 6:1,
that the weight ratio of guanidine and/or its salt to phenoxyethanol is in the range from 0.13:1 to 3.6:1,
that the weight ratio of guanidine and/or its salt to phenethyl alcohol is in the range from 0.15:1 to 12:1,
that the weight ratio of guanidine and/or its salt to phenylpropanol is in the range from 0.4:1 to 6:1,
that the weight ratio of guanidine and/or its salt to benzyl alcohol is in the range from 1:1 to 12:1,
that the weight ratio of guanidine and/or its salt to isopropanol is in the range from 0.004:1 to 3:1,
that the weight ratio of guanidine and/or its salt to ethylenediaminetetraacetic acid is in the range from 0.6:1 to 37:1,
that the weight ratio of guanidine and/or its salt to (1-hydroxyethylidene)bisphosphonic acid is in the range from 0.6:1 to 1.5:1,
that the weight ratio of guanidine and/or its salt to sodium pyrithione is in the range from 3.6:1 to 180:1,
that the weight ratio of guanidine and/or its salt to zinc pyrithione is in the range from 3.6:1 to 180:1,
that the weight ratio of guanidine and/or its salt to o-phenylphenol is in the range from 0.62:1 to 49:1,
that the weight ratio of guanidine and/or its salt to sorbic acid and/or its salt is in the range from 0.1:1 to 50:1,
that the weight ratio of guanidine and/or its salt to benzoic acid and/or its salt is in the range from 0.25:1 to 88:1,
that the weight ratio of guanidine and/or its salt to salicylic acid and/or its salt is in the range from 0.24:1 to 43:1,
that the weight ratio of guanidine and/or its salt to lactic acid and/or its salt is in the range from 0.03:1 to 23:1,
that the weight ratio of guanidine and/or its salt to citric acid and/or its salt is in the range from 0.014:1 to 12:1,
that the weight ratio of guanidine and/or its salt to zinc is in the range from 0.77:1 to 12:1,
where the basis in the determination of the weight ratio in each case is the content with respect to the guanidine, without taking into account any counterion, in the composition.

In one embodiment of the present invention, the aqueous composition is characterized in that it is an industrial product selected from the group consisting of: lignosulfonates and starch preparation in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids, cooling lubricants and biocidal products.

The content of the components (a) and (b) in the above-defined industrial products (the use concentration) may vary over wide ranges depending on the intended use and is typically determined by the person skilled in the art in the field of biocides. The concentration ranges specified below give the person skilled in the art an indication of the amounts to be used in each case:

The amount of component (a), guanidine and/or its salt, which is present in the industrial products may vary over wide ranges and is generally in the range from 100 to 10 000 ppm, preferably in an amount in the range from 200 to 7500 ppm, and more preferably in an amount in the range from 300 to 5000 ppm, where the proportion relates to the guanidine content in the overall industrial product.

The amount of component (b) present in the industrial products may likewise vary over wide ranges:

5-Chloro-2-methyl-4-isothiazolin-3-one (CIT), when present as component (b) in the aqueous composition or the industrial product, is generally present in an amount in the range from 0.5 to 200 ppm, preferably in an amount of 5 to 100 ppm, more preferably in an amount of 10 to 50 ppm, especially preferably in an amount of 15 to 30 ppm.

2-Methyl-4-isothiazolin-3-one (MIT), when present as component (b) in the aqueous composition or the industrial product, is generally present in an amount in the range from 0.5 to 200 ppm, preferably in an amount of 1 to 150 ppm, more preferably in an amount of 5 to 125 ppm, especially preferably in an amount of 10 to 100 ppm.

1,2-Benzisothiazolin-3-one (BIT), when present as component (b) in the aqueous composition or the industrial product, is generally present in an amount in the range from 1 to 500 ppm, preferably in an amount of 5 to 500 ppm, more preferably in an amount of 10 to 500 ppm.

N-Butyl-1,2-benzisothiazolin-3-one (BBIT), when present as component (b) in the aqueous composition or the industrial product, is generally present in an amount in the range from 5 to 2500 ppm, preferably in an amount of 10 to 2000 ppm, more preferably in an amount of 10 to 1500 ppm.

N-Methyl-1,2-benzisothiazolin-3-one (MBIT), when present as component (b) in the aqueous composition or the industrial product, is generally present in an amount in the range from 1 to 500 ppm, preferably in an amount of 5 to 500 ppm, more preferably in an amount of 10 to 1000 ppm.

Octylisothiazolinone (OIT), when present as component (b) in the aqueous composition or the industrial product, is generally present in an amount in the range from 1 to 2500 ppm, preferably in an amount of 5 to 2000 ppm, more preferably in an amount of 10 to 1500 ppm.

Bronopol, when present as component (b) in the aqueous composition or the industrial product, is generally present in an amount in the range from 1 to 1000 ppm, preferably in an amount of 5 to 750 ppm, more preferably in an amount of 10 to 500 ppm.

Dibromonitrilopropionamide (DBNPA), when present as component (b) in the aqueous composition or the industrial product, is generally present in an amount in the range from 1 to 1000 ppm, preferably in an amount of 5 to 750 ppm, more preferably in an amount of 10 to 500 ppm.

Dibromodicyanobutane (DBDCB), when present as a further component in the product preserved with the composition of the invention, is generally in an amount in the range from 1 to 1000 ppm, preferably in an amount of 5 to 750 ppm, more preferably in an amount of 10 to 500 ppm.

Iodopropynyl butylcarbamate (IPBC), when present as component (b) in the aqueous composition or the industrial product, is generally present in an amount in the range from 10 to 5000 ppm, preferably in an amount of 25 to 4500 ppm, more preferably in an amount of 50 to 4000 ppm.

Aminomethylpropanol (AMP), when present as component (b) in the aqueous composition or the industrial product, is generally present in an amount in the range from 10 to 10 000 ppm, preferably in an amount of 25 to 7500 ppm, more preferably in an amount of 50 to 5000 ppm.

Aminoethylpropanediol (AEPD), when present as component (b) in the aqueous composition or the industrial product, is generally present in an amount in the range from 10 to 10 000 ppm, preferably in an amount of 25 to 7500 ppm, more preferably in an amount of 50 to 5000 ppm.

Monoethanolamine (MEA), when present as component (b) in the aqueous composition or the industrial product, is generally present in an amount in the range from 10 to 10 000 ppm, preferably in an amount of 25 to 7500 ppm, more preferably in an amount of 50 to 5000 ppm.

Ethylhexylglycerol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Hexylglycerol, when present as component (b) in the aqueous composition or the industrial product, is generally present in an amount in the range from 10 to 10 000 ppm, preferably in an amount of 50 to 7500 ppm, more preferably in an amount of 100 to 5000 ppm. 30 Pentane-1,2-diol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Hexane-1,2-diol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Heptane-1,2-diol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Octane-1,2-diol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Phenoxyethanol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Phenethyl alcohol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Phenylpropanol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Benzyl alcohol, when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Isopropanol, when present as component (b) in the aqueous composition or the industrial product, is generally present in an amount in the range from 10 to 30 000 ppm, preferably in an amount of 50 to 20 000 ppm, more preferably in an amount of 100 to 15 000 ppm.

Ethylenediaminetetraacetic acid (EDTA), when present as component (b) in the aqueous composition or the industrial product preserved product, is generally present in an amount in the range from 10 to 10 000 ppm, preferably in an amount of 50 to 7500 ppm, more preferably in an amount of 100 to 5000 ppm.

(1-Hydroxyethylidene)bisphosphonic acid (HEDP), when present as component (b) in the aqueous composition or the industrial product, is generally present in an amount in the range from 10 to 10 000 ppm, preferably in an amount of 50 to 7500 ppm, more preferably in an amount of 100 to 5000 ppm.

Sodium pyrithione, when present as component (b) in the aqueous composition or the industrial product, is generally present in an amount in the range from 1 to 2500 ppm, preferably in an amount of 5 to 1500 ppm, more preferably in an amount of 10 to 1000 ppm.

Zinc pyrithione, when present as component (b) in the aqueous composition or the industrial product, is generally present in an amount in the range from 1 to 2500 ppm, preferably in an amount of 5 to 1500 ppm, more preferably in an amount of 10 to 1000 ppm.

o-Phenylphenol, when present as component (b) in the aqueous composition or the industrial product, is generally present in an amount in the range from 1 to 10 000 ppm, preferably in an amount of 10 to 5000 ppm, more preferably in an amount of 25 to 2500 ppm, especially preferably in an amount of 50 to 1500 ppm.

Sorbic acid, when present as component (b) in the aqueous composition or the industrial product, is generally present in an amount in the range from 1 to 10 000 ppm, preferably in an amount of 5 to 7500 ppm, more preferably in an amount of 10 to 5000 ppm.

Benzoic acid, when present as component (b) in the aqueous composition or the industrial product, is generally present in an amount in the range from 1 to 10 000 ppm, preferably in an amount of 5 to 7500 ppm, more preferably in an amount of 10 to 5000 ppm.

Salicylic acid, when present as component (b) in the aqueous composition or the industrial product, is generally present in an amount in the range from 1 to 10 000 ppm, preferably in an amount of 5 to 7500 ppm, more preferably in an amount of 10 to 5000 ppm.

Lactic acid, when present as component (b) in the aqueous composition or the industrial product, is generally present in an amount in the range from 1 to 50 000 ppm, preferably in an amount of 5 to 25 000 ppm, more preferably in an amount of 10 to 15 000 ppm.

Citric acid, when present as component (b) in the aqueous composition or the industrial product, is generally present in an amount in the range from 1 to 100 000 ppm, preferably in an amount of 5 to 50 000 ppm, more preferably in an amount of 10 to 25 000 ppm.

Zinc, when present as component (b) in the aqueous composition or the industrial product, is generally present in an amount in the range from 10 to 5000 ppm, preferably in an amount of 25 to 2500 ppm, preferably in an amount of 50 to 1000 ppm, especially preferably in an amount of 100 to 500 ppm.

The present invention further relates to the use of the above-defined, preferably aqueous compositions for in-can preservation, or the use for the preservation of industrial products, selected from the group consisting of lignosulfonates and starch preparation in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids and cooling lubricants.

In a further embodiment, the present invention relates to the use of:
(a) guanidine and/or a salt of unsubstituted guanidine
   for improvement of the antimicrobial efficacy of one or more compound(s) selected from the group, (b) consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, bronopol, dibromonitrilopropionamide, dibromodicyanobutane, iodopropynyl butylcarbamate, aminomethylpropanol, aminoethylpropanediol, monoethanolamine, ethylhexylglycerol, hexylglycerol, pentane-1,2-diol, hexane-1,2-diol, heptane-1,2-diol, octane-1,2-diol, phenoxyethanol, phenethyl alcohol, phenylpropanol, benzyl alcohol, isopropanol, ethylenediaminetetraacetic acid, (1-hydroxyethylidene)bisphosphonic acid, sodium pyrithione, zinc pyrithione, o-phenylphenol, sorbic acid, benzoic acid, salicylic acid, lactic acid, citric acid and zinc.

As can be inferred from the examples adduced below, the use of guanidine or its salt, which has not been known as an antimicrobial active to date, leads to a surprising synergistic increase in effect of the at least one further component from group (b) shown above.

Because of this surprising increase in effect, the at least one biocidal active component from group (b) can be used in distinctly low concentrations in the presence of guanidine. The amounts of components (a) and (b) used may vary over wide ranges and are, for example, in the range from 0.01% to 10%, preferably in the range from 0.02% to 5% and more preferably in the range from 0.03% to 3%, based on the overall composition in which the components are present.

Particularly advantageous improvements in antimicrobial efficacy can be achieved when the weight ratio of guanidine and/or its salt to 5-chloro-2-methylisothiazolin-3-one is in the range from 62:1 to 9270:1 and/or the weight ratio of guanidine and/or its salt to 2-methyl-4-isothiazolin-3-one is in the range from 10.3:1 to 773:1 and/or the weight ratio of guanidine and/or its salt to 1,2-benzisothiazolin-3-one is in the range from 1.3:1 to 309:1 and/or the weight ratio of guanidine and/or its salt to N-butyl-1,2-benzisothiazolin-3-one is in the range from 0.52:1 to 309:1 and/or the weight ratio of guanidine and/or its salt to N-methyl-1,2-benzisothiazolin-3-one is in the range from 7.8:1 to 618:1 and/or the weight ratio of guanidine and/or its salt to N-octylisothiazolin-3-one is in the range from 1.4:1 to 82:1 and/or the weight ratio of guanidine and/or its salt to bronopol is in the range from 7.8:1 to 824:1 and/or the weight ratio of guanidine and/or its salt to 2,2-dibromo-3-nitrilopropionamide is in the range from 7.8:1 to 3090:1 and/or the weight ratio of guanidine and/or its salt to dibromodicyanobutane is in the range from 0.78:1 to 309:1 and/or the weight ratio of guanidine and/or its salt to iodopropynyl butylcarbamate is in the range from 0.83:1 to 103:1 and/or the weight ratio of guanidine and/or its salt to 2-amino-2-methyl-1-propanol is in the range from 0.3:1 to 20:1 and/or the weight ratio of guanidine and/or its salt to 2-aminoethylpropane-1,3-diol is in the range from 0.2:1 to 15:1 and/or the weight ratio of guanidine and/or its salt to monoethanolamine is in the range from 0.2:1 to 30:1 and/or the weight ratio of guanidine and/or its salt to ethylhexylglycerol is in the range from 0.5:1 to 15:1 and/or the weight ratio of guanidine and/or its salt to hexylglycerol is in the range from 0.5:1 to 15:1, preferably in the range from 0.5:1 to 10:1, and/or the weight ratio of guanidine and/or its salt to pentane-1,2-diol is in the range from 0.07:1 to 7.5:1 and/or the weight ratio of guanidine and/or its salt to hexane-1,2-diol is in the range from 0.06:1 to 15:1 and/or the weight ratio of guanidine and/or its salt to heptane-1,2-diol is in the range from 0.25:1 to 30:1 and/or the weight ratio of guanidine and/or its salt to octane-1,2-diol is in the range from 0.2:1 to 6:1 and/or the weight ratio of guanidine and/or its salt to phenoxyethanol is in the range from 0.13:1 to 3.6:1 and/or the weight ratio of guanidine and/or its salt to phenethyl alcohol is in the range from 0.15:1 to 12:1 and/or the weight ratio of guanidine and/or its salt to phenylpropanol is in the range from 0.4:1 to 6:1 and/or the weight ratio of guanidine and/or its salt to benzyl alcohol is in the range from 1:1 to 12:1 and/or the weight ratio of guanidine and/or its salt to isopropanol is in the range from 0.004:1 to 3:1 and/or the weight ratio of guanidine and/or its salt to ethylenediaminetetraacetic acid is in the range from 0.6:1 to 37:1 and/or the weight ratio of guanidine and/or its salt to (1-hydroxyethylidene)bisphosphonic acid is in the range from 0.6:1 to 1.5:1 and/or the weight ratio of guanidine and/or its salt to sodium pyrithione is in the range from 3.6:1 to 180:1 and/or the weight ratio of guanidine and/or its salt to zinc pyrithione is in the range from 3.6:1 to 180:1 and/or the weight ratio of guanidine and/or its salt to o-phenylphenol is in the range from 0.62:1 to 49:1 and/or the weight ratio of guanidine and/or its salt to sorbic acid and/or its salt is in the range from 0.1:1 to 50:1 and/or the weight ratio of guanidine and/or its salt to benzoic acid and/or its salt is in the range from 0.25:1 to 88:1 and/or the weight ratio of guanidine and/or its salt to salicylic acid and/or its salt is in the range from 0.24:1 to 43:1 and/or the weight ratio of guanidine and/or its salt to lactic acid and/or its salt is in the range from 0.03:1 to 23:1 and/or the weight ratio of guanidine and/or its salt to citric acid and/or its salt is in the range from 0.014:1 to 12:1, and/or the weight ratio of guanidine and/or its salt to zinc is in the range from 0.77:1 to 12:1, where the basis in the determination of the weight ratio in each case is the total content of guanidine and acid in the composition.

### THE FOLLOWING EXAMPLES SERVE FOR FURTHER ILLUSTRATION OF THE PRESENT INVENTION

### Study of the Synergistic Interaction

The synergism of a combination of guanidine (added in the form of guanidine hydrochloride) with a biocide or a substance selected from the group consisting of 5-chloro-2-methyl-4-isothiazolin-3-one (CIT), 2-methyl-4-isothiazolin-3-one (MIT), 1,2-benzisothiazolin-3-one (BIT), N-butyl-1,2-benzisothiazolin-3-one (BBIT), N-methyl-1,2-benzisothiazolin-3-one (MBIT), octylisothiazolinone (OIT), bronopol, dibromonitrilopropionamide (DBNPA), dibromodicyanobutane (DBDCB), iodopropynyl butylcarbamate (IPBC), aminomethylpropanol (AMP), aminoethylpropanediol (AEPD), monoethanolamine (MEA), ethylhexylglycerol, hexylglycerol, pentane-1,2-diol, hexane-1,2-diol, heptane-1,2-diol, octane-1,2-diol, phenoxyethanol, benzyl alcohol, isopropanol, ethylenediaminetetraacetic acid (EDTA), (1-hydroxyethylidene)bisphosphonic acid (HEDP), pyrithione, o-phenylphenol (oPP), sorbic acid, benzoic acid, salicylic acid, lactic acid, citric acid and zinc oxide (ZnO) was examined for synergistic interaction.

Test organisms used were Gram-negative bacterial species from the group of pseudomonads, Pseudomonas putida DSM 115323 and Pseudomonas spec. DSM 115322. For this purpose, mixtures with different concentrations of the respective active substances were prepared and tested for their effect on the pseudomonads. The test was run in Müller-Hinton broth MHB with a cell density of 10⁶ microbes per ml. When organic acids are used as a combination partner with the guanidine, MHB was adjusted to pH 5.5.

The incubation was run in microplates at 30° C. for 48 hours. After 48 hours, the batches were evaluated for turbidity resulting from growth, and optical density was additionally determined photometrically. In this way, the minimum inhibitory concentrations (MICs) of the two actives were determined individually and in combination.

The synergism that occurred was represented numerically by calculating the synergy index (SI). The calculation was done according to the standard method of F. C. Kull et al., Applied Microbiology, vol. 9 (1961), p. 538.

This involves calculating the synergy index (SI) by the following formula:

$$Synergy index SI = {Q}_{a} / {Q}_{A} + {Q}_{b} / {Q}_{B}$$

Qₐ=concentration of component A in the A+B mixture
Q_{A}=concentration of component A as the sole biocide
Q_{b}=concentration of component B in the A+B mixture
Q_{B}=concentration of component B as the sole biocide

If the synergy index is greater than 1, this means that there is antagonism. If the synergy index assumes the value 1, this means that the effect of the two biocides/compounds is additive. If the synergy index assumes a value of less than 1, this means that there is synergism between the two biocides/compounds.

### Example 1: Study of the Synergistic Interaction Between guanidine and 5-chloro-2-methyl-4-isothiazolin-3-one (CIT)

Calculation of the synergy index of guanidine and CIT with respect to Pseudomonas putida DSM 115323 with an incubation time of 48 hours at 30° C.

TABLE 1

| Qa (guanidine) | Qb (CIT) | Synergy index |
|---|---|---|
| [ppm] | [ppm] | Qa/QA + Qb/QB |
| 0 | 3.0 | 1.00 |
| 155 | 2.5 | 0.86 |
| 618 | 2 | 0.77 |
| 1545 | 1.5 | 0.75 |
| 3090 | 1 | 0.83 |
| 4635 | 0.5 | 0.92 |
| 6180 | 0 | 1.00 |

Qa: Concentration of guanidine in the mixture that shows an endpoint
QA: Concentration of guanidine as the sole agent that shows an endpoint
Qb: Concentration of CIT in the mixture that shows an endpoint
QB: Concentration of CIT as the sole agent that shows an endpoint

Table 1 shows that the optimum synergism, i.e. the lowest synergy index (0.75) of a composition of guanidine and CIT, is at a ratio of 1545 ppm guanidine to 1.5 ppm CIT. Synergism can be demonstrated when the weight ratio of guanidine to CIT is in the range from 62:1 to 9270:1.

### Example 2: Study of the Synergistic Interaction Between guanidine and 2-methyl-4-isothiazolin-3-one (MIT)

Calculation of the synergy index of guanidine and MIT with respect to Pseudomonas spec. DSM 115322 with an incubation time of 48 hours at 30° C.

TABLE 2

| Qa (guanidine) | Qb (MIT) | Synergy index |
|---|---|---|
| [ppm] | [ppm] | Qa/QA + Qb/QB |
| 0 | 75 | 1.00 |
| 618 | 60 | 0.87 |
| 1545 | 50 | 0.83 |
| 3090 | 30 | 0.73 |
| 4635 | 20 | 0.77 |
| 6180 | 15 | 0.87 |
| 7725 | 10 | 0.97 |
| 9269 | 0 | 1.00 |

Qa: Concentration of guanidine in the mixture that shows an endpoint
QA: Concentration of guanidine as the sole agent that shows an endpoint
Qb: Concentration of MIT in the mixture that shows an endpoint
QB: Concentration of MIT as the sole agent that shows an endpoint

Table 2 shows that the optimum synergism, i.e. the lowest synergy index (0.73) of a composition of guanidine and MIT, is at a ratio of 3090 ppm guanidine to 30 ppm MIT. Synergism can be demonstrated when the weight ratio of guanidine to MIT is in the range from 10.3:1 to 773:1.

### Example 3: Study of the Synergistic Interaction Between guanidine and 1,2-benzisothiazolin-3-one (BIT)

Calculation of the synergy index of guanidine and BIT with respect to Pseudomonas spec. DSM 115322 with an incubation time of 48 hours at 30° C.

TABLE 3

| Qa (guanidine) | Qb (BIT) | Synergy index |
|---|---|---|
| [ppm] | [ppm] | Qa/QA + Qb/QB |
| 0 | 300 | 1.00 |
| 309 | 250 | 0.87 |
| 1545 | 175 | 0.75 |
| 3090 | 100 | 0.67 |
| 4635 | 75 | 0.75 |
| 6180 | 50 | 0.83 |
| 7725 | 25 | 0.92 |
| 9269 | 0 | 1.00 |

Qa: Concentration of guanidine in the mixture that shows an endpoint
QA: Concentration of guanidine as the sole agent that shows an endpoint
Qb: Concentration of BIT in the mixture that shows an endpoint
QB: Concentration of BIT as the sole agent that shows an endpoint

Table 3 shows that the optimum synergism, i.e. the lowest synergy index (0.67) of a composition of guanidine and BIT, is at a ratio of 3090 ppm guanidine to 100 ppm BIT. Synergism can be demonstrated when the weight ratio of guanidine to BIT is in the range from 1.3:1 to 309:1.

### Example 4: Study of the Synergistic Interaction Between guanidine and N-butyl-1,2-benzisothiazolin-3-one (BBIT)

Calculation of the synergy index of guanidine and BBIT with respect to Pseudomonas spec. DSM 115322 with an incubation time of 48 hours at 30° C.

TABLE 4

| Qa (guanidine) | Qb (BBIT) | Synergy index |
|---|---|---|
| [ppm] | [ppm] | Qa/QA + Qb/QB |
| 0 | 400 | 1.00 |
| 155 | 300 | 0.77 |
| 309 | 300 | 0.78 |
| 1545 | 200 | 0.67 |
| 3090 | 150 | 0.71 |
| 4635 | 125 | 0.81 |
| 6180 | 75 | 0.85 |
| 7725 | 25 | 0.90 |
| 9269 | 0 | 1.00 |

Qa: Concentration of guanidine in the mixture that shows an endpoint
QA: Concentration of guanidine as the sole agent that shows an endpoint
Qb: Concentration of BBIT in the mixture that shows an endpoint
QB: Concentration of BBIT as the sole agent that shows an endpoint

Table 4 shows that the optimum synergism, i.e. the lowest synergy index (0.67) of a composition of guanidine and BBIT, is at a ratio of 1545 ppm guanidine to 200 ppm BBIT. Synergism can be demonstrated when the weight ratio of guanidine to BBIT is in the range from 0.52:1 to 309:1.

### Example 5: Study of the Synergistic Interaction Between guanidine and N-methyl-1,2-benzisothiazolin-3-one (MBIT)

Calculation of the synergy index of guanidine and MBIT with respect to Pseudomonas spec. DSM 115322 with an incubation time of 48 hours at 30° C.

TABLE 5

| Qa (guanidine) | Qb (MBIT) | Synergy index |
|---|---|---|
| [ppm] | [ppm] | Qa/QA + Qb/QB |
| 0 | 300 | 1.00 |
| 1545 | 200 | 0.83 |
| 3090 | 150 | 0.83 |
| 3090 | 125 | 0.75 |
| 4635 | 100 | 0.83 |
| 6180 | 50 | 0.83 |
| 7725 | 12.5 | 0.88 |
| 9269 | 0 | 1.00 |

Qa: Concentration of guanidine in the mixture that shows an endpoint
QA: Concentration of guanidine as the sole agent that shows an endpoint
Qb: Concentration of MBIT in the mixture that shows an endpoint
QB: Concentration of MBIT as the sole agent that shows an endpoint

Table 5 shows that the optimum synergism, i.e. the lowest synergy index (0.75) of a composition of guanidine and MBIT, is at a ratio of 3090 ppm guanidine to 125 ppm MBIT. Synergism can be demonstrated when the weight ratio of guanidine to MBIT is in the range from 7.8:1 to 618:1.

### Example 6: Study of the Synergistic Interaction Between guanidine and octylisothiazolinone (OIT)

Calculation of the synergy index of guanidine and OIT with respect to Pseudomonas spec. DSM 115322 with an incubation time of 48 hours at 30° C.

TABLE 6

| Qa (guanidine) | Qb (OIT) | Synergy index |
|---|---|---|
| [ppm] | [ppm] | Qa/QA + Qb/QB |
| 0 | 250 | 1.00 |
| 309 | 225 | 0.93 |
| 618 | 200 | 0.87 |
| 1590 | 175 | 0.87 |
| 4635 | 100 | 0.90 |
| 6180 | 75 | 0.97 |
| 9269 | 0 | 1.00 |

Qa: Concentration of guanidine in the mixture that shows an endpoint
QA: Concentration of guanidine as the sole agent that shows an endpoint
Qb: Concentration of OIT in the mixture that shows an endpoint
QB: Concentration of OIT as the sole agent that shows an endpoint

Table 6 shows that the optimum synergism, i.e. the lowest synergy index (0.87) of a composition of guanidine and OIT, is at a ratio of 618 to 1590 ppm guanidine to 200 to 175 ppm OIT. Synergism can be demonstrated when the weight ratio of guanidine to OIT is in the range from 1.4:1 to 82:1.

### Example 7: Study of the Synergistic Interaction Between guanidine and bronopol

Calculation of the synergy index of guanidine and bronopol with respect to Pseudomonas spec. DSM 115322 with an incubation time of 48 hours at 30° C.

TABLE 7

| Qa | Qb | |
|---|---|---|
| (guanidine) | (bronopol) | Synergy index |
| [ppm] | [ppm] | Qa/QA + Qb/QB |
| 0 | 25 | 1.00 |
| 155 | 20 | 0.82 |
| 1545 | 15 | 0.77 |
| 3090 | 12.5 | 0.83 |
| 4635 | 10 | 0.90 |
| 6180 | 7.5 | 0.97 |
| 9269 | 0 | 1.00 |

Qa: Concentration of guanidine in the mixture that shows an endpoint
QA: Concentration of guanidine as the sole agent that shows an endpoint
Qb: Concentration of bronopol in the mixture that shows an endpoint
QB: Concentration of bronopol as the sole agent that shows an endpoint

Table 7 shows that the optimum synergism, i.e. the lowest synergy index (0.77) of a composition of guanidine and bronopol, is at a ratio of 1545 ppm guanidine to 15 ppm bronopol. Synergism can be demonstrated when the weight ratio of guanidine to bronopol is in the range from 7.8:1 to 824:1.

### Example 8: Study of the Synergistic Interaction Between guanidine and dibromonitrilopropionamide (DBNPA)

Calculation of the synergy index of guanidine and DBNPA with respect to Pseudomonas spec. DSM 115322 with an incubation time of 48 hours at 30° C.

TABLE 8

| Qa (guanidine) | Qb (DBNPA) | Synergy index |
|---|---|---|
| [ppm] | [ppm] | Qa/QA + Qb/QB |
| 0 | 25 | 1.00 |
| 155 | 20 | 0.82 |
| 618 | 20 | 0.87 |
| 3090 | 12.5 | 0.83 |
| 4635 | 10 | 0.90 |
| 7725 | 2.5 | 0.93 |
| 9269 | 0 | 1.00 |

Qa: Concentration of guanidine in the mixture that shows an endpoint
QA: Concentration of guanidine as the sole agent that shows an endpoint
Qb: Concentration of DBNPA in the mixture that shows an endpoint
QB: Concentration of DBNPA as the sole agent that shows an endpoint

Table 8 shows that the optimum synergism, i.e. the lowest synergy index (0.82) of a composition of guanidine and DBNPA, is at a ratio of 155 ppm guanidine to 20 ppm DBNPA. Synergism can be demonstrated when the weight ratio of guanidine to DBNPA is in the range from 7.8:1 to 3090:1.

### Example 9: Study of the Synergistic Interaction Between guanidine and dibromodicyanobutane (DBDCB)

Calculation of the synergy index of guanidine and DBDCB with respect to Pseudomonas spec. DSM 115322 with an incubation time of 48 hours at 30° C.

TABLE 9

| Qa (guanidine) | Qb (DBDCB) | Synergy index |
|---|---|---|
| [ppm] | [ppm] | Qa/QA + Qb/QB |
| 0 | 250 | 1.00 |
| 155 | 200 | 0.82 |
| 1590 | 150 | 0.77 |
| 4635 | 75 | 0.80 |
| 6180 | 50 | 0.87 |
| 7725 | 25 | 0.93 |
| 9269 | 0 | 1.00 |

Qa: Concentration of guanidine in the mixture that shows an endpoint
QA: Concentration of guanidine as the sole agent that shows an endpoint
Qb: Concentration of DBDCB in the mixture that shows an endpoint
QB: Concentration of DBDCB as the sole agent that shows an endpoint

Table 9 shows that the optimum synergism, i.e. the lowest synergy index (0.77) of a composition of guanidine and DBDCB, is at a ratio of 1590 ppm guanidine to 150 ppm DBDCB. Synergism can be demonstrated when the weight ratio of guanidine to DBDCB is in the range from 0.78:1 to 309:1.

### Example 10: Study of the Synergistic Interaction Between guanidine and iodopropynyl butylcarbamate (IPBC)

Calculation of the synergy index of guanidine and IPBC with respect to Pseudomonas spec. DSM 115322 with an incubation time of 48 hours at 30° C.

TABLE 10

| Qa (guanidine) | Qb (IPBC) | Synergy index |
|---|---|---|
| [ppm] | [ppm] | Qa/QA + Qb/QB |
| 0 | 1000 | 1.00 |
| 618 | 750 | 0.87 |
| 4635 | 300 | 0.83 |
| 6180 | 200 | 0.90 |
| 7725 | 75 | 0.93 |
| 9269 | 0 | 1.00 |

Qa: Concentration of guanidine in the mixture that shows an endpoint
QA: Concentration of guanidine as the sole agent that shows an endpoint
Qb: Concentration of IPBC in the mixture that shows an endpoint
QB: Concentration of IPBC as the sole agent that shows an endpoint

Table 10 shows that the optimum synergism, i.e. the lowest synergy index (0.83) of a composition of guanidine and IPBC, is at a ratio of 4635 ppm guanidine to 300 ppm IPBC. Synergism can be demonstrated when the weight ratio of guanidine to IPBC is in the range from 0.83:1 to 103:1.

### Example 11: Study of the Synergistic Interaction Between guanidine and 2-amino-2-methyl-1-propanol (AMP)

Calculation of the synergy index of guanidine and AMP with respect to Pseudomonas spec. DSM 115322 with an incubation time of 48 hours at 30° C.

TABLE 11

| Qa (guanidine) | Qb (AMP) | Synergy index |
|---|---|---|
| [ppm] | [ppm] | Qa/QA + Qb/QB |
| 0 | 2500 | 1.00 |
| 618 | 2000 | 0.87 |
| 1545 | 1500 | 0.77 |
| 3090 | 1000 | 0.73 |
| 4635 | 750 | 0.80 |
| 6180 | 500 | 0.87 |
| 7725 | 375 | 0.98 |
| 9269 | 0 | 1.00 |

Qa: Concentration of guanidine in the mixture that shows an endpoint
QA: Concentration of guanidine as the sole agent that shows an endpoint
Qb: Concentration of AMP in the mixture that shows an endpoint
QB: Concentration of AMP as the sole agent that shows an endpoint

Table 11 shows that the optimum synergism, i.e. the lowest synergy index (0.73) of a composition of guanidine and AMP, is at a ratio of 3090 ppm guanidine to 1000 ppm AMP. Synergism can be demonstrated when the weight ratio of guanidine to AMP is in the range from 0.3:1 to 20:1.

### Example 12: Study of the Synergistic Interaction Between guanidine and 2-aminoethylpropane-1,3-diol (AEPD)

Calculation of the synergy index of guanidine and AEPD with respect to Pseudomonas spec. DSM 115322 with an incubation time of 48 hours at 30° C.

TABLE 12

| Qa (guanidine) | Qb (AEPD) | Synergy index |
|---|---|---|
| [ppm] | [ppm] | Qa/QA + Qb/QB |
| 0 | 5000 | 1.00 |
| 618 | 3750 | 0.82 |
| 3090 | 2000 | 0.73 |
| 4635 | 1500 | 0.80 |
| 6180 | 1000 | 0.87 |
| 7725 | 500 | 0.93 |
| 9269 | 0 | 1.00 |

Qa: Concentration of guanidine in the mixture that shows an endpoint
QA: Concentration of guanidine as the sole agent that shows an endpoint
Qb: Concentration of AEPD in the mixture that shows an endpoint
QB: Concentration of AEPD as the sole agent that shows an endpoint

Table 12 shows that the optimum synergism, i.e. the lowest synergy index (0.73) of a composition of guanidine and AEPD, is at a ratio of 3090 ppm guanidine to 2000 ppm AEPD. Synergism can be demonstrated when the weight ratio of guanidine to AEPD is in the range from 0.2:1 to 15:1.

### Example 13: Study of the Synergistic Interaction Between guanidine and monoethanolamine (MEA)

Calculation of the synergy index of guanidine and MEA with respect to Pseudomonas spec. DSM 115322 with an incubation time of 48 hours at 30° C.

TABLE 13

| Qa (guanidine) | Qb (MEA) | Synergy index |
|---|---|---|
| [ppm] | [ppm] | Qa/QA + Qb/QB |
| 0 | 2000 | 1.00 |
| 309 | 1750 | 0.91 |
| 1545 | 1250 | 0.79 |
| 3090 | 1000 | 0.83 |
| 4635 | 750 | 0.88 |
| 6180 | 500 | 0.92 |
| 7725 | 250 | 0.96 |
| 9269 | 0 | 1.00 |

Qa: Concentration of guanidine in the mixture that shows an endpoint
QA: Concentration of guanidine as the sole agent that shows an endpoint
Qb: Concentration of MEA in the mixture that shows an endpoint
QB: Concentration of MEA as the sole agent that shows an endpoint

Table 13 shows that the optimum synergism, i.e. the lowest synergy index (0.79) of a composition of guanidine and MEA, is at a ratio of 1545 ppm guanidine to 1250 ppm MEA. Synergism can be demonstrated when the weight ratio of guanidine to MEA is in the range from 0.2:1 to 30:1.

### Example 14: Study of the Synergistic Interaction Between guanidine and ethylhexylglycerol (EHG)

Calculation of the synergy index of guanidine and EHG with respect to Pseudomonas spec. DSM 115322 with an incubation time of 48 hours at 30° C.

TABLE 14

| Qa (guanidine) | Qb (EHG) | Synergy index |
|---|---|---|
| [ppm] | [ppm] | Qa/QA + Qb/QB |
| 0 | 2000 | 1.00 |
| 618 | 1250 | 0.69 |
| 3090 | 1000 | 0.83 |
| 4635 | 500 | 0.75 |
| 6180 | 400 | 0.87 |
| 9269 | 0 | 1.00 |

Qa: Concentration of guanidine in the mixture that shows an endpoint
QA: Concentration of guanidine as the sole agent that shows an endpoint
Qb: Concentration of EHG in the mixture that shows an endpoint
QB: Concentration of EHG as the sole agent that shows an endpoint

Table 14 shows that the optimum synergism, i.e. the lowest synergy index (0.69) of a composition of guanidine and EHG, is at a ratio of 618 ppm guanidine to 1250 ppm EHG. Synergism can be demonstrated when the weight ratio of guanidine to EHG is in the range from 0.5:1 to 15:1.

### Example 15: Study of the Synergistic Interaction Between guanidine and hexylglycerol

Calculation of the synergy index of guanidine and hexylglycerol with respect to Pseudomonas spec. DSM 115322 with an incubation time of 48 hours at 30° C.

TABLE 15

| Qa (guanidine) | Qb (hexylglycerol) | Synergy index |
|---|---|---|
| [ppm] | [ppm] | Qa/QA + Qb/QB |
| 0 | 2000 | 1.00 |
| 618 | 1250 | 0.69 |
| 3090 | 1000 | 0.83 |
| 4635 | 500 | 0.75 |
| 6180 | 400 | 0.87 |
| 9269 | 0 | 1.00 |

Qa: Concentration of guanidine in the mixture that shows an endpoint
QA: Concentration of guanidine as the sole agent that shows an endpoint
Qb: Concentration of hexylglycerol in the mixture that shows an endpoint
QB: Concentration of hexylglycerol as the sole agent that shows an endpoint

Table 15 shows that the optimum synergism, i.e. the lowest synergy index (0.69) of a composition of guanidine and hexylglycerol, is at a ratio of 618 ppm guanidine to 1250 ppm hexylglycerol. Synergism can be demonstrated when the weight ratio of guanidine to hexylglycerol is in the range from 0.5:1 to 15:1.

### Example 16: Study of the Synergistic Interaction Between guanidine and pentane-1,2-diol

Calculation of the synergy index of guanidine and pentane-1,2-diol with respect to Pseudomonas spec. DSM 115322 with an incubation time of 48 hours at 30° C.

TABLE 16

| Qa (guanidine) | Qb (pentane-1,2- | Synergy index |
|---|---|---|
| [ppm] | diol) [ppm] | Qa/QA + Qb/QB |
| 0 | 10000 | 1.00 |
| 618 | 9000 | 0.97 |
| 3090 | 6000 | 0.93 |
| 4653 | 4000 | 0.90 |
| 6180 | 2000 | 0.87 |
| 7725 | 1000 | 0.93 |
| 9269 | 0 | 1.00 |

Qa: Concentration of guanidine in the mixture that shows an endpoint
QA: Concentration of guanidine as the sole agent that shows an endpoint
Qb: Concentration of pentane-1,2-diol in the mixture that shows an endpoint
QB: Concentration of pentane-1,2-diol as the sole agent that shows an endpoint

Table 16 shows that the optimum synergism, i.e. the lowest synergy index (0.87) of a composition of guanidine and pentane-1,2-diol, is at a ratio of 6180 ppm guanidine to 2000 ppm pentane-1,2-diol. Synergism can be demonstrated when the weight ratio of guanidine to pentane-1,2-diol is in the range from 0.07:1 to 7.5:1.

### Example 17: Study of the Synergistic Interaction Between guanidine and hexane-1,2-diol

Calculation of the synergy index of guanidine and hexane-1,2-diol with respect to Pseudomonas spec. DSM 115322 with an incubation time of 48 hours at 30° C.

TABLE 17

| Qa (guanidine) | Qb (hexane-1,2- | Synergy index |
|---|---|---|
| [ppm] | diol) [ppm] | Qa/QA + Qb/QB |
| 0 | 7500 | 1.00 |
| 309 | 5000 | 0.70 |
| 1545 | 3750 | 0.67 |
| 3090 | 2500 | 0.67 |
| 4653 | 2000 | 0.77 |
| 6180 | 1500 | 0.87 |
| 7725 | 500 | 0.90 |
| 9269 | 0 | 1.00 |

Qa: Concentration of guanidine in the mixture that shows an endpoint
QA: Concentration of guanidine as the sole agent that shows an endpoint
Qb: Concentration of hexane-1,2-diol in the mixture that shows an endpoint
QB: Concentration of hexane-1,2-diol as the sole agent that shows an endpoint

Table 17 shows that the optimum synergism, i.e. the lowest synergy index (0.67) of a composition of guanidine and hexane-1,2-diol, is at a ratio of 1545 to 3090 ppm guanidine to 3750 to 2500 ppm hexane-1,2-diol. Synergism can be demonstrated when the weight ratio of guanidine to hexane-1,2-diol is in the range from 0.06:1 to 15:1.

### Example 18: Study of the Synergistic Interaction Between guanidine and heptane-1,2-diol

Calculation of the synergy index of guanidine and heptane-1,2-diol with respect to Pseudomonas spec. DSM 115322 with an incubation time of 48 hours at 30° C.

TABLE 18

| Qa (guanidine) | Qb (heptane-1,2- | Synergy index |
|---|---|---|
| [ppm] | diol) [ppm] | Qa/QA + Qb/QB |
| 0 | 3750 | 1.00 |
| 618 | 2500 | 0.73 |
| 1545 | 2000 | 0.70 |
| 4653 | 1000 | 0.77 |
| 6180 | 750 | 0.87 |
| 7725 | 250 | 0.90 |
| 9269 | 0 | 1.00 |

Qa: Concentration of guanidine in the mixture that shows an endpoint
QA: Concentration of guanidine as the sole agent that shows an endpoint
Qb: Concentration of heptane-1,2-diol in the mixture that shows an endpoint
QB: Concentration of heptane-1,2-diol as the sole agent that shows an endpoint

Table 18 shows that the optimum synergism, i.e. the lowest synergy index (0.70) of a composition of guanidine and heptane-1,2-diol, is at a ratio of 1545 ppm guanidine to 2000 ppm heptane-1,2-diol. Synergism can be demonstrated when the weight ratio of guanidine to heptane-1,2-diol is in the range from 0.25:1 to 30:1.

### Example 19: Study of the Synergistic Interaction Between guanidine and octane-1,2-diol

Calculation of the synergy index of guanidine and octane-1,2-diol with respect to Pseudomonas spec. DSM 115322 with an incubation time of 48 hours at 30° C.

TABLE 19

| Qa (guanidine) | Qb (octane-1,2- | Synergy index |
|---|---|---|
| [ppm] | diol) [ppm] | Qa/QA + Qb/QB |
| 0 | 2000 | 1.00 |
| 309 | 1750 | 0.91 |
| 1545 | 1500 | 0.92 |
| 4635 | 750 | 0.88 |
| 9269 | 0 | 1.00 |

Qa: Concentration of guanidine in the mixture that shows an endpoint
QA: Concentration of guanidine as the sole agent that shows an endpoint
Qb: Concentration of octane-1,2-diol in the mixture that shows an endpoint
QB: Concentration of octane-1,2-diol as the sole agent that shows an endpoint

Table 19 shows that the optimum synergism, i.e. the lowest synergy index (0.88) of a composition of guanidine and octane-1,2-diol, is at a ratio of 4635 ppm guanidine to 750 ppm octane-1,2-diol. Synergism can be demonstrated when the weight ratio of guanidine to octane-1,2-diol is in the range from 0.2:1 to 6:1.

### Example 20: Study of the Synergistic Interaction Between guanidine and phenoxyethanol

Calculation of the synergy index of guanidine and phenoxyethanol with respect to Pseudomonas spec. DSM 115322 with an incubation time of 48 hours at 30° C.

TABLE 20

| Qa (guanidine) | Qb (phenoxyethanol) | Synergy index |
|---|---|---|
| [ppm] | [ppm] | Qa/QA + Qb/QB |
| 0 | 3000 | 1.00 |
| 309 | 2500 | 0.87 |
| 1545 | 2000 | 0.83 |
| 4635 | 1250 | 0.92 |
| 9269 | 0 | 1.00 |

Qa: Concentration of guanidine in the mixture that shows an endpoint
QA: Concentration of guanidine as the sole agent that shows an endpoint
Qb: Concentration of phenoxyethanol in the mixture that shows an endpoint
QB: Concentration of phenoxyethanol as the sole agent that shows an endpoint

Table 20 shows that the optimum synergism, i.e. the lowest synergy index (0.83) of a composition of guanidine and phenoxyethanol, is at a ratio of 1545 ppm guanidine to 2000 ppm phenoxyethanol. Synergism can be demonstrated when the weight ratio of guanidine to phenoxyethanol is in the range from 0.13:1 to 3.6:1.

### Example 21: Study of the Synergistic Interaction Between guanidine and phenethyl alcohol

Calculation of the synergy index of guanidine and phenethyl alcohol with respect to Pseudomonas spec. DSM 115322 with an incubation time of 48 hours at 30° C.

TABLE 21

| Qa (guanidine) | Qb (phenethyl | Synergy index |
|---|---|---|
| [ppm] | alcohol) [ppm] | Qa/QA + Qb/QB |
| 0 | 2500 | 1.00 |
| 309 | 2000 | 0.83 |
| 3090 | 1250 | 0.83 |
| 6180 | 500 | 0.87 |
| 9269 | 0 | 1.00 |

Qa: Concentration of guanidine in the mixture that shows an endpoint
QA: Concentration of guanidine as the sole agent that shows an endpoint
Qb: Concentration of phenethyl alcohol in the mixture that shows an endpoint
QB: Concentration of phenethyl alcohol as the sole agent that shows an endpoint

Table 21 shows that the optimum synergism, i.e. the lowest synergy index (0.83) of a composition of guanidine and phenethyl alcohol, is at a ratio of 309 to 3090 ppm guanidine to 1250 to 2000 ppm phenethyl alcohol. Synergism can be demonstrated when the weight ratio of guanidine and phenethyl alcohol is in the range from 0.15:1 to 12:1.

### Example 22: Study of the Synergistic Interaction Between guanidine and phenylpropanol

Calculation of the synergy index of guanidine and phenylpropanol with respect to Pseudomonas spec. DSM 115322 with an incubation time of 48 hours at 30° C.

TABLE 22

| Qa (guanidine) | Qb (phenylpropanol) | Synergy index |
|---|---|---|
| [ppm] | [ppm] | Qa/QA + Qb/QB |
| 0 | 2000 | 1.00 |
| 618 | 1500 | 0.82 |
| 1545 | 1250 | 0.79 |
| 4635 | 750 | 0.88 |
| 9105 | 0 | 1.00 |

Qa: Concentration of guanidine in the mixture that shows an endpoint
QA: Concentration of guanidine as the sole agent that shows an endpoint
Qb: Concentration of phenylpropanol in the mixture that shows an endpoint
QB: Concentration of phenylpropanol as the sole agent that shows an endpoint

Table 22 shows that the optimum synergism, i.e. the lowest synergy index (0.79) of a composition of guanidine and phenylpropanol, is at a ratio of 1545 ppm guanidine to 1250 ppm phenylpropanol. Synergism can be demonstrated when the weight ratio of guanidine and phenylpropanol is in the range from 0.4:1 to 6:1.

### Example 23: Study of the Synergistic Interaction Between guanidine and benzyl alcohol

Calculation of the synergy index of guanidine and benzyl alcohol with respect to Pseudomonas spec. DSM 115322 with an incubation time of 48 hours at 30° C.

TABLE 23

| Qa (guanidine) | Qb (benzyl | Synergy index |
|---|---|---|
| [ppm] | alcohol) [ppm] | Qa/QA + Qb/QB |
| 0 | 2000 | 1.00 |
| 1545 | 1500 | 0.92 |
| 3090 | 1000 | 0.83 |
| 3090 | 750 | 0.71 |
| 6180 | 500 | 0.92 |
| 9269 | 0 | 1.00 |

Qa: Concentration of guanidine in the mixture that shows an endpoint
QA: Concentration of guanidine as the sole agent that shows an endpoint
Qb: Concentration of benzyl alcohol in the mixture that shows an endpoint
QB: Concentration of benzyl alcohol as the sole agent that shows an endpoint

Table 23 shows that the optimum synergism, i.e. the lowest synergy index (0.71) of a composition of guanidine and benzyl alcohol, is at a ratio of 3090 ppm guanidine to 750 ppm benzyl alcohol. Synergism can be demonstrated when the weight ratio of guanidine to benzyl alcohol is in the range from 1:1 to 12:1.

### Example 24: Study of the Synergistic Interaction Between guanidine and isopropanol

Calculation of the synergy index of guanidine and isopropanol with respect to Pseudomonas spec. DSM 115322 with an incubation time of 48 hours at 30° C.

TABLE 24

| Qa (guanidine) | Qb (isopropanol) | Synergy index |
|---|---|---|
| [ppm] | [ppm] | Qa/QA + Qb/QB |
| 0 | 60000 | 1.00 |
| 155 | 40000 | 0.68 |
| 309 | 30000 | 0.53 |
| 3090 | 20000 | 0.67 |
| 4635 | 15000 | 0.75 |
| 6180 | 10000 | 0.83 |
| 7725 | 2500 | 0.88 |
| 9269 | 0 | 1.00 |

Qa: Concentration of guanidine in the mixture that shows an endpoint
QA: Concentration of guanidine as the sole agent that shows an endpoint
Qb: Concentration of isopropanol in the mixture that shows an endpoint
QB: Concentration of isopropanol as the sole agent that shows an endpoint

Table 24 shows that the optimum synergism, i.e. the lowest synergy index (0.53) of a composition of guanidine and isopropanol, is at a ratio of 309 ppm guanidine to 30000 ppm isopropanol. Synergism can be demonstrated when the weight ratio of guanidine to isopropanol is in the range from 0.004:1 to 3:1.

### Example 25: Study of the Synergistic Interaction Between guanidine and ethylenediaminetetraacetic acid (EDTA)

Calculation of the synergy index of guanidine and EDTA with respect to Pseudomonas spec. DSM 115322 with an incubation time of 48 hours at 30° C.

TABLE 25

| Qa (guanidine) | Qb (EDTA) | Synergy index |
|---|---|---|
| [ppm] | [ppm] | Qa/QA + Qb/QB |
| 0 | 300 | 1.00 |
| 155 | 250 | 0.85 |
| 1545 | 200 | 0.83 |
| 3090 | 175 | 0.92 |
| 4635 | 125 | 0.92 |
| 9269 | 0 | 1.00 |

Qa: Concentration of guanidine in the mixture that shows an endpoint
QA: Concentration of guanidine as the sole agent that shows an endpoint
Qb: Concentration of EDTA in the mixture that shows an endpoint
QB: Concentration of EDTA as the sole agent that shows an endpoint

Table 25 shows that the optimum synergism, i.e. the lowest synergy index (0.83) of a composition of guanidine and EDTA, is at a ratio of 1545 ppm guanidine to 200 ppm EDTA. Synergism can be demonstrated when the weight ratio of guanidine to EDTA is in the range from 0.6:1 to 37:1.

### Example 26: Study of the Synergistic Interaction Between guanidine and (1-hydroxyethylidene)bisphosphonic acid (HEDP)

Calculation of the synergy index of guanidine and HEDP with respect to Pseudomonas spec. DSM 115322 with an incubation time of 48 hours at 30° C.

TABLE 26

| Qa (guanidine) | Qb (HEDP) | Synergy index |
|---|---|---|
| [ppm] | [ppm] | Qa/QA + Qb/QB |
| 0 | 300 | 1.00 |
| 618 | 1000 | 0.73 |
| 1545 | 1000 | 0.83 |
| 9269 | 0 | 1.00 |

Qa: Concentration of guanidine in the mixture that shows an endpoint
QA: Concentration of guanidine as the sole agent that shows an endpoint
Qb: Concentration of HEDP in the mixture that shows an endpoint
QB: Concentration of HEDP as the sole agent that shows an endpoint

Table 26 shows that the optimum synergism, i.e. the lowest synergy index (0.73) of a composition of guanidine and HEDP, is at a ratio of 618 ppm guanidine to 1000 ppm HEDP. Synergism can be demonstrated when the weight ratio of guanidine to HEDP is in the range from 0.6:1 to 1.5:1.

### Example 27: Study of the Synergistic Interaction Between guanidine and pyrithione (Added in the form of sodium pyrithione)

Calculation of the synergy index of guanidine and pyrithione with respect to Pseudomonas spec. DSM 115322 with an incubation time of 48 hours at 30° C.

TABLE 27

| Qa (guanidine) | Qb (pyrithione) | Synergy index |
|---|---|---|
| [ppm] | [ppm] | Qa/QA + Qb/QB |
| 0 | 127 | 1.00 |
| 309 | 85 | 0.70 |
| 618 | 85 | 0.73 |
| 1545 | 85 | 0.83 |
| 3090 | 63 | 0.83 |
| 6180 | 34 | 0.93 |
| 9269 | 0 | 1.00 |

Qa: Concentration of guanidine in the mixture that shows an endpoint
QA: Concentration of guanidine as the sole agent that shows an endpoint
Qb: Concentration of pyrithione in the mixture that shows an endpoint
QB: Concentration of pyrithione as the sole agent that shows an endpoint

Table 27 shows that the optimum synergism, i.e. the lowest synergy index (0.70) of a composition of guanidine and pyrithione, is at a ratio of 309 ppm guanidine to 85 ppm pyrithione. Synergism can be demonstrated when the weight ratio of guanidine to pyrithione is in the range from 3.6:1 to 180:1.

### Example 28: Study of the Synergistic Interaction Between guanidine and o-phenylphenol (oPP)

Calculation of the synergy index of guanidine and oPP with respect to Pseudomonas spec. DSM 115322 with an incubation time of 48 hours at 30° C.

TABLE 28

| Qa (guanidine) | Qb (oPP) | Synergy index |
|---|---|---|
| [ppm] | [ppm] | Qa/QA + Qb/QB |
| 0 | 750 | 1.00 |
| 309 | 500 | 0.70 |
| 309 | 375 | 0.53 |
| 1545 | 250 | 0.50 |
| 3090 | 250 | 0.67 |
| 4635 | 125 | 0.67 |
| 6180 | 125 | 0.83 |
| 9269 | 0 | 1.00 |

Qa: Concentration of guanidine in the mixture that shows an endpoint
QA: Concentration of guanidine as the sole agent that shows an endpoint
Qb: Concentration of oPP in the mixture that shows an endpoint
QB: Concentration of oPP as the sole agent that shows an endpoint

Table 28 shows that the optimum synergism, i.e. the lowest synergy index (0.50) of a composition of guanidine and oPP, is at a ratio of 1545 ppm guanidine to 250 ppm oPP. Synergism can be demonstrated when the weight ratio of guanidine to oPP is in the range from 0.62:1 to 49:1.

### Example 29: Study of the Synergistic Interaction Between guanidine and sorbic acid (Added in the form of potassium sorbate)

Calculation of the synergy index of guanidine and sorbic acid with respect to Pseudomonas spec. DSM 115322 with an incubation time of 48 hours at 30° C.

TABLE 29

| Qa (guanidine) | Qb (sorbic acid) | Synergy index |
|---|---|---|
| [ppm] | [ppm] | Qa/QA + Qb/QB |
| 0 | 1849 | 1.00 |
| 155 | 1479 | 0.81 |
| 309 | 1479 | 0.83 |
| 618 | 1110 | 0.65 |
| 1545 | 925 | 0.63 |
| 3090 | 555 | 0.55 |
| 6180 | 370 | 0.70 |
| 7725 | 277 | 0.78 |
| 9269 | 185 | 0.85 |
| 12359 | 0 | 1.00 |

Qa: Concentration of guanidine in the mixture that shows an endpoint
QA: Concentration of guanidine as the sole agent that shows an endpoint
Qb: Concentration of sorbic acid in the mixture that shows an endpoint
QB: Concentration of sorbic acid as the sole agent that shows an endpoint

Table 29 shows that the optimum synergism, i.e. the lowest synergy index (0.55) of a composition of guanidine and sorbic acid, is at a ratio of 3090 ppm guanidine to 555 ppm sorbic acid. Synergism can be demonstrated when the weight ratio of guanidine to sorbic acid is in the range from 0.1:1 to 50:1.

### Example 30: Study of the Synergistic Interaction Between guanidine and benzoic acid (Added in the form of sodium benzoate)

Calculation of the synergy index of guanidine and benzoic acid with respect to Pseudomonas spec. DSM 115322 with an incubation time of 48 hours at 30° C.

TABLE 30

| Qa (guanidine) | Qb (benzoic acid) | Synergy index |
|---|---|---|
| [ppm] | [ppm] | Qa/QA + Qb/QB |
| 0 | 1680 | 1.00 |
| 309 | 1260 | 0.78 |
| 618 | 1050 | 0.68 |
| 1545 | 840 | 0.63 |
| 3090 | 706 | 0.63 |
| 4635 | 400 | 0.63 |
| 6180 | 315 | 0.69 |
| 9269 | 105 | 0.81 |
| 12359 | 0 | 1.00 |

Qa: Concentration of guanidine in the mixture that shows an endpoint
QA: Concentration of guanidine as the sole agent that shows an endpoint
Qb: Concentration of benzoic acid in the mixture that shows an endpoint
QB: Concentration of benzoic acid as the sole agent that shows an endpoint

Table 30 shows that the optimum synergism, i.e. the lowest synergy index (0.63) of a composition of guanidine and benzoic acid, is at a ratio of 1545 to 4635 ppm guanidine to 840 to 400 ppm benzoic acid. Synergism can be demonstrated when the weight ratio of guanidine to benzoic acid is in the range from 0.25:1 to 88:1.

### Example 31: Study of the Synergistic Interaction Between guanidine and salicylic acid (Added in the form of sodium salicyate)

Calculation of the synergy index of guanidine and salicylic acid with respect to Pseudomonas spec. DSM 115322 with an incubation time of 48 hours at 30° C.

TABLE 31

| Qa (guanidine) | Qb (salicylic | Synergy index |
|---|---|---|
| [ppm] | acid) [ppm] | Qa/QA + Qb/QB |
| 0 | 1713 | 1.00 |
| 309 | 1285 | 0.76 |
| 618 | 1071 | 0.65 |
| 1545 | 856 | 0.63 |
| 3090 | 642 | 0.63 |
| 4635 | 428 | 0.63 |
| 6180 | 312 | 0.69 |
| 9269 | 214 | 0.88 |
| 12359 | 0 | 1.00 |

Qa: Concentration of guanidine in the mixture that shows an endpoint
QA: Concentration of guanidine as the sole agent that shows an endpoint
Qb: Concentration of salicylic acid in the mixture that shows an endpoint
QB: Concentration of salicylic acid as the sole agent that shows an endpoint

Table 31 shows that the optimum synergism, i.e. the lowest synergy index (0.63) of a composition of guanidine and salicylic acid, is at a ratio of 1545 to 4635 ppm guanidine to 856 to 428 ppm salicylic acid. Synergism can be demonstrated when the weight ratio of guanidine to salicylic acid is in the range from 0.24:1 to 43:1.

### Example 32: Study of the Synergistic Interaction Between guanidine and lactic acid (Added in the form of sodium L-lactate)

Calculation of the synergy index of guanidine and lactic acid with respect to Pseudomonas spec. DSM 115322 with an incubation time of 48 hours at 30° C.

TABLE 32

| Qa (guanidine) | Qb (lactic | Synergy index |
|---|---|---|
| [ppm] | acid) [ppm] | Qa/QA + Qb/QB |
| 0 | 15896 | 1.00 |
| 309 | 11922 | 0.78 |
| 618 | 11922 | 0.80 |
| 4635 | 5961 | 0.75 |
| 4635 | 3974 | 0.63 |
| 6180 | 1987 | 0.63 |
| 7725 | 795 | 0.68 |
| 9269 | 397 | 0.78 |
| 12359 | 0 | 1.00 |

Qa: Concentration of guanidine in the mixture that shows an endpoint
QA: Concentration of guanidine as the sole agent that shows an endpoint
Qb: Concentration of lactic acid in the mixture that shows an endpoint
QB: Concentration of lactic acid as the sole agent that shows an endpoint

Table 32 shows that the optimum synergism, i.e. the lowest synergy index (0.63) of a composition of guanidine and lactic acid, is at a ratio of 4635 to 6180 ppm guanidine to 3974 to 1987 ppm lactic acid. Synergism can be demonstrated when the weight ratio of guanidine to lactic acid is in the range from 0.03:1 to 23:1.

### Example 33: Study of the Synergistic Interaction Between guanidine and citric acid (Added in the form of trisodium citrate)

Calculation of the synergy index of guanidine and citric acid with respect to Pseudomonas spec. DSM 115322 with an incubation time of 48 hours at 30° C.

TABLE 33

| Qa (guanidine) | Qb (citric | Synergy index |
|---|---|---|
| [ppm] | acid) [ppm] | Qa/QA + Qb/QB |
| 0 | 51293 | 1.00 |
| 309 | 21983 | 0.45 |
| 618 | 21983 | 0.48 |
| 3090 | 10991 | 0.46 |
| 4635 | 5496 | 0.48 |
| 6180 | 3664 | 0.57 |
| 7725 | 1832 | 0.66 |
| 9269 | 733 | 0.76 |
| 12359 | 0 | 1.00 |

Qa: Concentration of guanidine in the mixture that shows an endpoint
QA: Concentration of guanidine as the sole agent that shows an endpoint
Qb: Concentration of citric acid in the mixture that shows an endpoint
QB: Concentration of citric acid as the sole agent that shows an endpoint

Table 33 shows that the optimum synergism, i.e. the lowest synergy index (0.45) of a composition of guanidine and citric acid, is at a ratio of 309 ppm guanidine to 21983 ppm citric acid. Synergism can be demonstrated when the weight ratio of guanidine to citric acid is in the range from 0.014:1 to 12:1.

### Example 34: Study of the Synergistic Interaction Between guanidine and zinc (Added in the form of zinc oxide)

In example 34, the synergistic interaction between guanidine and a zinc compound (zinc oxide) with respect to microbial infestation was examined in an emulsion paint by adding particular amounts of guanidine in the form of guanidine hydrochloride and a zinc compound in the form of zinc oxide, and tested for stability to microbial infestation. The paint tested was an emulsion paint based on styrene-acrylate binder (PVK 77%, pH 8.8) for indoor use, produced in the laboratory, without addition of the usual preservatives.

The samples were inoculated repeatedly, three times in total, with a bacterial cell suspension of the following composition (2% v/w).

### Bacteria Mixture A:

Alcaligenes faecalis NCIMB 13145
Escherichia coli DSM 13631
Burkholderia cepacia DSM 9241
Staphylococcus aureus DSM 799
Pseudomonas aeruginosa DSM 50071
Pseudomonas putida DSM 13624

The cell suspension of the bacteria mixture A was produced by growing the individual bacteria at 30° C. for 24 h in liquid culture on a shaker. The growth medium used for the bacteria was Müller-Hinton liquid medium. After growing, the individual liquid cultures were centrifuged, and the cells were resuspended in physiological saline solution. In order to adjust the mixture to a total cell count of 10⁹/ml, the individual bacteria suspensions, if necessary, were diluted accordingly before being combined with saline solution. The cell count of the inoculum was determined in each case by chamber counting.

After each inoculation and after incubation at 30° C. for 7 days, microbial infestation was evaluated in the samples by determining the live bacteria count per g of paint (colony-forming units, CFU/g). The CFU/g was determined each time by taking an aliquot (1 g) from the previously homogenized sample and running a serial decadic dilution series in physiological saline solution (0.9% NaCl) by streaking on tryptic soy agar, followed by incubation of the agar plates at 30° C. for 48 h.

TABLE 34
Example 34
Inoculation with bacteria mixture A, cell count 10⁹/ml

| | CFU/g after inoculation | | |
|---|---|---|---|
| | Incubation days [d] | | |
| | 1. | 2. | 3. |
| Test product/concentration | 7 d | 7 d | 7 d |
| Emulsion paint | | | |
| No additives | 5.2 × 10⁵ | >10⁶ | >10⁶ |
| Zinc oxide 125 ppm (100 ppm Zn) | 9.4 × 10⁵ | >10⁶ | >10⁶ |
| Zinc oxide 250 ppm (201 ppm Zn) | 2.2 × 10⁴ | >10⁶ | >10⁶ |
| Zinc oxide 500 ppm (402 ppm Zn) | 6.6 × 10⁴ | >10⁶ | >10⁶ |
| Zinc oxide 1000 ppm (803 ppm Zn) | 9.9 × 10³ | >10⁶ | >10⁶ |
| Zinc oxide 2500 ppm (2009 ppm Zn) | <100 | <100 | <100 |
| Guanidine hydrochloride 1000 ppm | 8.7 × 10⁵ | >10⁶ | >10⁶ |
| (618 ppm guanidine) | | | |
| Guanidine hydrochloride 2500 ppm | <100 | <100 | >10⁶ |
| (1545 ppm guanidine) | | | |
| Guanidine hydrochloride 5000 ppm | <100 | <100 | <100 |
| (3090 ppm guanidine) | | | |
| 125 ppm zinc oxide (100 ppm Zn) + | <100 | <100 | 1.5 × 10² |
| 2500 ppm guanidine hydrochloride | | | |
| (1545 ppm guanidine) | | | |
| 250 ppm zinc oxide (201 ppm Zn) + | <100 | <100 | <100 |
| 2500 ppm guanidine hydrochloride | | | |
| (1545 ppm guanidine) | | | |
| 500 ppm zinc oxide (402 ppm Zn) + | <100 | <100 | <100 |
| 1000 ppm guanidine hydrochloride | | | |
| (618 ppm guanidine) | | | |
| 1000 ppm zinc oxide (803 ppm Zn) + | <100 | <100 | <100 |
| 1000 ppm guanidine hydrochloride | | | |
| (618 ppm guanidine) | | | |

A synergistic effect between guanidine and zinc was demonstrated using the endpoints of the results after 3 inoculations up to a maximum of 1000 CFU/g.

TABLE 35
Example 34

| Qa (guanidine) | Qb (Zn) | Synergy index |
|---|---|---|
| [ppm] | [ppm] | Qa/QA + Qb/QB |
| 0 | 2009 | 1.00 |
| 618 | 803 | 0.60 |
| 618 | 402 | 0.40 |
| 1545 | 201 | 0.60 |
| 1545 | 100 | 0.55 |
| 3090 | 0 | 1.00 |

Qa: Concentration of guanidine in the mixture that shows an endpoint
QA: Concentration of guanidine as the sole agent that shows an endpoint
Qb: Concentration of zinc in the mixture that shows an endpoint
QB: Concentration of zinc as the sole agent that shows an endpoint

Table 35 shows that the optimum synergism, i.e. the lowest synergy index (0.40) of a composition of guanidine and zinc, is at a ratio of 618 ppm guanidine to 402 ppm zinc. Synergism can be demonstrated when the weight ratio of guanidine to zinc is in the range from 0.77:1 to 12:1.

In examples 35 to 38 below, synergistic interaction between guanidine and antimicrobial substances with respect to microbial infestation was studied using an emulsion paint and a laundry detergent or cleaning composition by adding particular amounts of guanidine salts and isothiazolinones and examining their stability against microbial infestation:

The paint tested was an emulsion paint based on styrene-acrylate binder (PVK 77%, pH 8.8) for indoor use, produced in the laboratory, without addition of the usual preservatives. The laundry detergent was a heavy-duty laundry detergent without preservatives (pH 8.1), and the cleaning composition was an all-purpose detergent without preservatives (pH 7.6), each likewise made in the laboratory, without addition of the otherwise usual conventional preservatives.

### Procedure:

To each paint was added—individually and in combination—particular concentrations of guanidinium hydrochloride, benzisothiazolinone (BIT), and a mixture of chloromethylisothiazolinone (CIT) and methylisothiazolinone (MIT). The laundry detergent and the cleaning composition were admixed with particular concentrations of guanidinium hydrochloride and benzisothiazolinone (BIT).

The resultant batches of the paint thus prepared were inoculated with a mixture of different bacteria species (bacteria mixture B); the batches of the laundry detergent and cleaning compositions thus prepared were inoculated with a yeast mixture.

### Bacteria Mixture B:

Pseudomonas spp. (Pseudomonas oleovorans group) DSM 33933
Pseudomonas aeruginosa DSM 33935
Pseudomonas oleovorans DSM 33936
Pseudomonas spec. DSM 33937
Pseudomonas aeruginosa DSM 33938

### Yeast Mixture:

Pichia manshurica DSM 12249
Rhodotorula mucilaginosa DSM 12248
Candida boidinii DSM 13622
Candida albicans DSM 1386

The inoculum was added to the respective sample in each inoculation at 2% (v/w) as a fresh cell suspension in a physiological saline solution (0.9% NaCl). The cell count of the inoculum added was 10⁹/ml for bacteria mixture A, 10⁸/ml for the yeast mixture, consisting in equal parts of the individual bacteria strains or yeast strains.

The cell suspension of the bacteria mixture was produced by growing the individual bacteria at 30° C. for 24 h in liquid culture on a shaker. The growth medium used for the bacteria was Müller-Hinton liquid medium. After growing, the individual liquid cultures were centrifuged, and the cells were resuspended in physiological saline solution. In order to adjust the mixture to a total cell count of 10⁹/ml, the individual bacteria suspensions, if necessary, were diluted accordingly before being combined with saline solution. The cell count of the inoculum was determined in each case by chamber counting.

The cell suspension of the yeast mixture was produced by growing the yeast strains on Sabouraud glucose-agar at 25° C. for 48 hours and washing down the cell lawn with physiological saline solution (0.9% NaCl). Further steps for establishment of a cell count of the inoculum suspension of 10⁸/ml were effected analogously to the production of the bacteria suspension.

In examples 35 to 38, the samples were inoculated once with the respective cell suspensions (2% v/w) and the development of the bacteria (bacteria mixture B) or yeasts was followed by a semiquantitative evaluation method. In the inoculated samples, microbial infestation was evaluated in each case directly after inoculation on day 1 and on day 6 (emulsion paint) after incubation at 30° C. for a further 5 days, or on day 3 (laundry detergent, cleaning composition) after incubation at 30° C. for a further 2 days. For this purpose, an aliquot was taken from each sample after homogenization using a sterile plastic inoculation loop (10 μl) and streaked evenly on agar plates (tryptic soy agar in the case of bacteria, Sabouraud glucose-agar in the case of yeasts). The streaked agar plates were then incubated at 30° C. for 48 hours (bacteria) or at 25° C. for 72 hours (yeasts). After incubation, the bacterial or yeast colonies that have grown on the agar plates were visually evaluated and quantified according to the following scheme:

| Evaluation | Growth on the agar surface |
|---|---|
| 0 | No growth |
| 1 | Minimal growth, 1 to 10 colonies visible over the |
| | entire streak |
| 2 | Light growth, maximum 100 colonies |
| 3 | Moderate growth, maximum 300 to 400 colonies |
| 4 | Uniform growth, >400 colonies, single colonies |
| | still clearly recognizable |
| 5 | Heavy growth, too many colonies to count, but no |
| | growth over the entire streak |
| 6 | Full growth, barely any single colonies still |
| | apparent, growth over the entire streak |

The results of examples 35 to 38 are shown in tables 36 to 39:

TABLE 36
Example 35
Inoculation 2% (w/v) with bacteria mixture B, cell count 10⁹/ml

Bacterial growth

| Concentration | Day 1 | Day 6 |
|---|---|---|
| Emulsion paint | | |
| No additives | 6 | 6 |
| +6000 ppm guanidine hydrochloride | 6 | 6 |
| (3708 ppm guanidine) | | |
| +500 ppm BIT | 6 | 6 |
| +300 ppm BIT + 1000 ppm guanidine | 6 | 0 |
| hydrochloride (618 ppm guanidine) | | |
| +200 ppm BIT + 2000 ppm guanidine | 6 | 0 |
| hydrochloride (1236 ppm guanidine) | | |

As can be inferred from the results shown in table 36, the synergistic interaction between BIT and guanidine, which has already been demonstrated above under laboratory conditions, can also be demonstrated in a practical application, in an emulsion paint.

TABLE 37
Example 36
Inoculation 2% (w/v) with bacteria mixture B, cell count 10⁹/ml

| | Bacterial growth | |
|---|---|---|
| Concentration | Day 1 | Day 6 |
| Emulsion paint | | |
| No additives | 6 | 6 |
| +6000 ppm guanidine hydrochloride (3708 ppm | 6 | 6 |
| guanidine) | | |
| +11 ppm CIT + 15 ppm MIT | 6 | 6 |
| +8.3 ppm CIT + 11 ppm MIT + 1000 ppm | 6 | 0 |
| guanidine hydrochloride (618 ppm guanidine) | | |
| +5.5 ppm CIT + 7.5 ppm MIT + 2000 ppm | 6 | 0 |
| guanidine hydrochloride (1236 ppm guanidine) | | |

As can be inferred from the results shown in table 37, the synergistic interaction between MIT and guanidine, which has already been demonstrated above under laboratory conditions, can also be demonstrated in a practical application, in an emulsion paint.

TABLE 38
Example 37
Inoculation 2% (w/v) with yeast mixture, cell count 10⁸/ml

Bacterial growth

| Concentration | Day 1 | Day 3 |
|---|---|---|
| Laundry detergent | | |
| No additives | 6 | 6 |
| +8000 ppm guanidine hydrochloride | 6 | 6 |
| (4944 ppm guanidine) | | |
| +100 ppm BIT | 6 | 4 |
| +30 ppm BIT + 3000 ppm guanidine | 6 | 2 |
| hydrochloride (1854 ppm guanidine) | | |
| +30 ppm BIT + 4000 ppm guanidine | 6 | 1 |
| hydrochloride (2472 ppm guanidine) | | |

As can be inferred from the results shown in table 38, the synergistic interaction between BIT and guanidine, which has already been demonstrated above under laboratory conditions, can also be demonstrated in a practical application, in a heavy-duty laundry detergent.

TABLE 39
Example 38
Inoculation 2% (w/v) with yeast mixture, cell count 10⁸/ml

Yeast growth

| Concentration | Day 1 | Day 3 |
|---|---|---|
| All-purpose detergent | | |
| No additives | 6 | 5 |
| +8000 ppm guanidine hydrochloride | 6 | 4 |
| (4944 ppm guanidine) | | |
| +100 ppm BIT | 6 | 4 |
| +30 ppm BIT + 3000 ppm guanidine | 6 | 0 |
| hydrochloride (1854 ppm guanidine) | | |
| +30 ppm BIT + 4000 ppm guanidine | 6 | 0 |
| hydrochloride (2472 ppm guanidine) | | |

As can be inferred from the results shown in table 39, the synergistic interaction between BIT and guanidine, which has already been demonstrated above under laboratory conditions, can also be demonstrated in a practical application, in a heavy-duty laundry detergent.

1. A composition comprising:
(a) guanidine and/or a salt of unsubstituted guanidine and
(b) at least one further component selected from the group consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, bronopol, dibromonitrilopropionamide, dibromodicyanobutane, iodopropynyl butylcarbamate, aminomethylpropanol, aminoethylpropanediol, monoethanolamine, ethylhexylglycerol, hexylglycerol, pentane-1,2-diol, hexane-1,2-diol, heptane-1,2-diol, octane-1,2-diol, phenoxyethanol, phenethyl alcohol, phenylpropanol, benzyl alcohol, isopropanol, ethylenediaminetetraacetic acid, (1-hydroxyethylidene)bisphosphonic acid, sodium pyrithione, zinc pyrithione, o-phenylphenol, sorbic acid, benzoic acid, salicylic acid, lactic acid, citric acid and zinc.

2. The composition as claimed in claim 1, characterized in that the weight ratio of guanidine and/or its salt to 5-chloro-2-methylisothiazolin-3-one is in the range from 62:1 to 9270:1,
that the weight ratio of guanidine and/or its salt to 2-methyl-4-isothiazolin-3-one is in the range from 10.3:1 to 773:1,
that the weight ratio of guanidine and/or its salt to 1,2-benzisothiazolin-3-one is in the range from 1.3:1 to 309:1,
that the weight ratio of guanidine and/or its salt to N-butyl-1,2-benzisothiazolin-3-one is in the range from 0.52:1 to 309:1,
that the weight ratio of guanidine and/or its salt to N-methyl-1,2-benzisothiazolin-3-one is in the range from 7.8:1 to 618:1,
that the weight ratio of guanidine and/or its salt to N-octylisothiazolin-3-one is in the range from 1.4:1 to 82:1,
that the weight ratio of guanidine and/or its salt to bronopol is in the range from 7.8:1 to 824:1,
that the weight ratio of guanidine and/or its salt to 2,2-dibromo-3-nitrilopropionamide is in the range from 7.8:1 to 3090:1,
that the weight ratio of guanidine and/or its salt to dibromodicyanobutane is in the range from 0.78:1 to 309:1,
that the weight ratio of guanidine and/or its salt to iodopropynyl butylcarbamate is in the range from 0.83:1 to 103:1,
that the weight ratio of guanidine and/or its salt to 2-amino-2-methyl-1-propanol is in the range from 0.3:1 to 20:1,
that the weight ratio of guanidine and/or its salt to 2-aminoethylpropane-1,3-diol is in the range from 0.2:1 to 15:1,
that the weight ratio of guanidine and/or its salt to monoethanolamine is in the range from 0.2:1 to 30:1,
that the weight ratio of guanidine and/or its salt to ethylhexylglycerol is in the range from 0.5:1 to 15:1,
that the weight ratio of guanidine and/or its salt to hexylglycerol is in the range from 0.5:1 to 15:1,
that the weight ratio of guanidine and/or its salt to pentane-1,2-diol is in the range from 0.07:1 to 7.5:1,
that the weight ratio of guanidine and/or its salt to hexane-1,2-diol is in the range from 0.06:1 to 15:1,
that the weight ratio of guanidine and/or its salt to heptane-1,2-diol is in the range from 0.25:1 to 30:1,
that the weight ratio of guanidine and/or its salt to octane-1,2-diol is in the range from 0.2:1 to 6:1,
that the weight ratio of guanidine and/or its salt to phenoxyethanol is in the range from 0.13:1 to 3.6:1,
that the weight ratio of guanidine and/or its salt to phenethyl alcohol is in the range from 0.15:1 to 12:1,
that the weight ratio of guanidine and/or its salt to phenylpropanol is in the range from 0.4:1 to 6:1,
that the weight ratio of guanidine and/or its salt to benzyl alcohol is in the range from 1:1 to 12:1,
that the weight ratio of guanidine and/or its salt to isopropanol is in the range from 0.004:1 to 3:1,
that the weight ratio of guanidine and/or its salt to ethylenediaminetetraacetic acid is in the range from 0.6:1 to 37:1,
that the weight ratio of guanidine and/or its salt to (1-hydroxyethylidene)bisphosphonic acid is in the range from 0.6:1 to 1.5:1,
that the weight ratio of guanidine and/or its salt to sodium pyrithione is in the range from 3.6:1 to 180:1,
that the weight ratio of guanidine and/or its salt to zinc pyrithione is in the range from 3.6:1 to 180:1,
that the weight ratio of guanidine and/or its salt to o-phenylphenol is in the range from 0.62:1 to 49:1,
that the weight ratio of guanidine and/or its salt to sorbic acid and/or its salt is in the range from 0.1:1 to 50:1,
that the weight ratio of guanidine and/or its salt to benzoic acid and/or its salt is in the range from 0.25:1 to 88:1,
that the weight ratio of guanidine and/or its salt to salicylic acid and/or its salt is in the range from 0.24:1 to 43:1,
that the weight ratio of guanidine and/or its salt to lactic acid and/or its salt is in the range from 0.03:1 to 23:1,
that the weight ratio of guanidine and/or its salt to citric acid and/or its salt is in the range from 0.014:1 to 12:1,
that the weight ratio of guanidine and/or its salt to zinc is in the range from 0.77:1 to 12:1,
where the basis in the determination of the weight ratio in each case is the content with respect to the guanidine or the further component, without taking into account any counterion, in the composition.

3. The composition as claimed in claim 1, characterized in that it contains the guanidine and/or its salt and the at least one further component in a total amount in the range from 0.01% to 10%, preferably in the range from 0.02% to 5% and more preferably in the range from 0.03% to 3%, based on the overall composition.

4. The composition as claimed in claim 1, characterized in that it contains the guanidine and/or its salt in an amount in the range from 100 to 10 000 ppm, preferably in an amount in the range from 200 to 7500 ppm, more preferably in an amount in the range from 300 to 5000 ppm, where the proportion relates to the guanidine content in the overall composition.

5. The composition as claimed in claim 1, characterized in that the composition:
contains 5-chloro-2-methyl-4-isothiazolin-3-one, when it is present as a further component, in an amount in the range from 0.5 to 200 ppm,
contains 2-methyl-4-isothiazolin-3-one, when it is present as a further component, in an amount in the range from 0.5 to 200 ppm,
contains 1,2-benzisothiazolin-3-one, when it is present as a further component, in an amount in the range from 1 to 500 ppm,
contains N-butyl-1,2-benzisothiazolin-3-one, when it is present as a further component, in an amount in the range from 5 to 2500 ppm,
contains N-methyl-1,2-benzisothiazolin-3-one, when it is present as a further component, in an amount in the range from 1 to 500 ppm,
contains octylisothiazolinone, when it is present as a further component, in an amount in the range from 1 to 2500 ppm,
contains bronopol, when as a further component, in an amount in the range from 1 to 1000 ppm,
contains dibromonitrilopropionamide, when it is present as a further component, in an amount in the range from 1 to 1000 ppm,
contains dibromodicyanobutane, when it is present as a further component, in an amount in the range from 1 to 1000 ppm,
contains iodopropynyl butylcarbamate, when it is present as a further component, in an amount in the range from 10 to 5000 ppm,
contains aminomethylpropanol, when it is present as a further component, in an amount in the range from 10 to 10 000 ppm,
contains aminoethylpropanediol, when it is present as a further component, in an amount in the range from 10 to 10 000 ppm,
contains monoethanolamine, when it is present as a further component, in an amount of 25 to 7500 ppm,
contains ethylhexylglycerol, when it is present as a further component, in an amount in the range from 10 to 10 000 ppm,
contains hexylglycerol, when it is present as a further component, in an amount in the range from 10 to 10 000 ppm,
contains pentane-1,2-diol, when it is present as a further component, in an amount in the range from 10 to 10 000 ppm,
contains hexane-1,2-diol, when it is present as a further component, in an amount in the range from 10 to 10 000 ppm,
contains heptane-1,2-diol, when it is present as a further component, in an amount in the range from 10 to 10 000 ppm,
contains octane-1,2-diol, when it is present as a further component, in an amount in the range from 10 to 10 000 ppm,
contains phenoxyethanol, when it is present as a further component, in an amount in the range from 10 to 10 000 ppm,
contains phenethyl alcohol, when it is present as a further component, in an amount in the range from 10 to 10 000 ppm,
contains phenylpropanol, when it is present as a further component, in an amount in the range from 10 to 10 000 ppm,
contains benzyl alcohol, when it is present as a further component, in an amount in the range from 10 to 10 000 ppm,
contains isopropanol, when it is present as a further component, in an amount in the range from 10 to 30 000 ppm,
contains ethylenediaminetetraacetic acid, when it is present as a further component, in an amount in the range from 10 to 10 000 ppm,
contains (1-hydroxyethylidene)bisphosphonic acid, when it is present as a further component, in an amount in the range from 10 to 10 000 ppm,
contains sodium pyrithione, when it is present as a further component, in an amount in the range from 1 to 2500 ppm,
contains zinc pyrithione, when it is present as a further component, in an amount in the range from 1 to 2500 ppm,
contains o-phenylphenol, when it is present as a further component, in an amount in the range from 1 to 10 000 ppm,
contains sorbic acid, when it is present as a further component, in an amount in the range from 1 to 10 000 ppm,
contains benzoic acid, when it is present as a further component, in an amount in the range from 1 to 10 000 ppm,
contains salicylic acid, when it is present as a further component, in an amount in the range from 1 to 10 000 ppm,
contains lactic acid, when it is present as a further component, in an amount in the range from 1 to 50 000 ppm,
contains citric acid, when it is present as a further component, in an amount in the range from 1 to 100 000 ppm, and
contains zinc, when it is present as a further component, in an amount in the range from 10 to 5000 ppm.

6. The composition as claimed in claim 1, characterized in that it has a water content of greater than 1% by weight.

7. The composition as claimed in claim 1, characterized in that it has a pH in the range from pH 3.5 to pH 12.

8. The composition as claimed in claim 1, characterized in that it contains as guanidine salt guanidine hydrochloride and/or guanidine carbonate.

9. The composition as claimed in claim 1, characterized in that the composition is an industrial product selected from the group consisting of:
lignosulfonates and starch preparations in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids, cooling lubricants and biocidal products.

10. The use of the composition as claimed in claim 8 for in-can preservation.

11. The use of the composition as claimed in claim 1 for the preservation of industrial products selected from the group consisting of lignosulfonates and starch preparations in paints, colors, varnishes, glazes and renders, emulsions, latices, polymer dispersions, chalk slurries, mineral slurries, ceramic compounds, adhesives, fragrances, casein-containing products, starch-containing products, bitumen emulsions, surfactant solutions, fuels, detergents, cleaning compositions, pigment pastes and pigment dispersions, inks, lithography fluids, thickeners, cosmetic products, toiletries, water cycles, wood processing fluids, petroleum production fluids, paper processing fluids, leather manufacturing fluids, textile manufacturing fluids, drilling and cutting oils, hydraulic fluids and cooling lubricants.

12. The use of:
(a) guanidine and/or a salt of unsubstituted guanidine for improving the antimicrobial efficacy of one or more compound(s) selected from the group
(b) consisting of 5-chloro-2-methyl-4-isothiazolin-3-one, 2-methyl-4-isothiazolin-3-one, 1,2-benzisothiazolin-3-one, N-butyl-1,2-benzisothiazolin-3-one, N-methyl-1,2-benzisothiazolin-3-one, octylisothiazolinone, bronopol, dibromonitrilopropionamide, dibromodicyanobutane, iodopropynyl butylcarbamate, aminomethylpropanol, aminoethylpropanediol, monoethanolamine, ethylhexylglycerol, hexylglycerol, pentane-1,2-diol, hexane-1,2-diol, heptane-1,2-diol, octane-1,2-diol, phenoxyethanol, phenethyl alcohol, phenylpropanol, benzyl alcohol, isopropanol, ethylenediaminetetraacetic acid, (1-hydroxyethylidene)bisphosphonic acid, sodium pyrithione, zinc pyrithione, o-phenylphenol, sorbic acid, benzoic acid, salicylic acid, lactic acid, citric acid and zinc.
